(19) United States
(12) Patent Application Publication
(10) Pub. No.: US 2019/0028273 A1
(43) Pub. Date: Jan. 24, 2019

(54) METHOD FOR SAVING DATA WITH MULTI-LAYER PROTECTION, IN PARTICULAR LOG-ON DATA AND PASSWORDS

(71) Applicant: Roland HARRAS, München (DE)

(72) Inventor: Roland HARRAS, München (DE)

(21) Appl. No.: 16/070,544

(22) PCT Filed: Jan. 17, 2017
(86) PCT No.: PCT/DE2017/200002

§ 371 Date: Jul. 17, 2018

(30) Foreign Application Priority Data
Jan. 18, 2016 (DE) 10 2016 000 328.6

(51) Int. Cl. H04L 9/08; G06F 21/45; H04L 29/06; H04L 9/16

(52) U.S. Cl. CPC H04L 9/0863; G06F 21/45; H04L 9/16; H04L 63/105; H04L 63/068

(57) ABSTRACT

Almost every month, there are new reports of hackers who were able to acquire millions of data items and passwords. The problem: even if data are sufficiently encrypted, there must be a key somewhere for decryption. If this key can be stolen, the best encryption is of no use. Instead of conventional keys, the present overall data protection concept uses future events as a secret basis for encryption. Data are coded repeatedly with variable and partly only transient keys which are not permanently stored but are coded with time codes which result from unpredictable future timer events and are therefore impossible to steal. Various measures protect keys against viewing even during the immediate use thereof, and an optional hardware expansion excludes any possibilities of manipulation, with the result that there is no longer any risk even in captured systems.

### A. BACKGROUND OR PROBLEM (TECHN. FIELD)

Users can or must register themselves (registration) in a wide variety of IT applications, and especially on Internet websites. For this purpose, usually a user name (often the eMail address) in combination with a password for authentication is specified. With this combination, the user can later log in again at any time to gain access to his personal settings, his account or the services assigned to him (usually by previous or following payment) (login). Billions of people sometimes have several so-called web accounts on various websites. Above all online shops, eBay etc, banks, travel portals, app providers, etc.

The respective (website) server/applications store these credentials/login data (username and password) mostly in databases either in plain text or encrypted.

Although access to these databases is protected by various methods, in recent years and months successful hacker attacks have accumulated masses of such credentials. Due to the often simple encryption, the fact that passwords are mostly—if ever—just hashed and the mass of captured data, those can be decrypted with correspondingly high computing power again. In some cases, the necessary key is also captured. Sometimes, however, the datas are captured unencrypted, because the server owners have not expected the success of such a hacker attack. The NSA affair has shown that many areas of our digital life are by no means as secure as we believed.

The resulting damage is enormous not only for the trust and image of each website; It carries a high risk of misuse of this data for the users. Since 95% of the users use these credentials multiple times in same form, i.e. for multiple applications or web pages, the capture of such credentials is a massive threat. Therefore a password obtained from a low protected website can be used to make purchases on various online shops on behalf of the user or to gain access to a user-used cloud (online storage) and by that unfortunately to intimate data and pictures and eventually also access far more sensitive areas such as online banking.

This is a massive and sometimes highly underestimated risk of our time since we are using the internet increasingly more in different areas of our lives.

The present invention is a method of protecting data from unauthorized viewing/access, which claims to be uncrackable, even in the highest level of attacks.

### B. CORE OF THE METHOD/PROCEDURE

Core of this Method is solving the main problem of any privacy or encryption process: it is about how to hide the keys. This is similar to a hidden treasure. The best hiding place is only as good as the clues are secret. But somebody has to know where the treasure is hidden . . . and that this treasure map is possibly divided by several people or places. This is how it works with the key of encrypted data. This key must be somewhere and the application that works with this data must be able to access it. So another program, such as a malicious program (virus, bootkits), can access it too. It just needs to know how the regular IT application accesses the key (s) and procure itself the appropriate rights. At last where and how they are hidden. To find this out, there are several possibilities.

Therefore, any data encryption is potentially at risk as soon as an attacker can gain access to the respective system. It therefore makes no sense to encrypt data more intensively or multiple times because the weak point remains: The keys can always be found and stolen by spending enough work, time and money on it.

For this reason, in the past, one has focused on protective mechanisms to prevent such access. Unfortunately, despite elaborate firewalls, virus scanners and even the most sophisticated security technology, it has been shown, that 100% protection against the intrusion of an attacker is not possible.

The present invention solves this problem by also encrypting the keys used (original key), resulting in so-called Futurekeys. But that alone would have the same problem again. Where to save the key encrypted the original key? For this reason, this key is generated from a time code based on a future system time (time X) and a timer is set which at this future time X (e.g. via a so-called interrupt, ideally an NMI (Not Maskable Interrupt)) calls a program (the timer program), which allows the decryption of the Futurekeys at this time X with the time code generated from the then given system time again. The original keys are then available again although in the meantime they were only present encrypted, without the key used for, existing elsewhere.

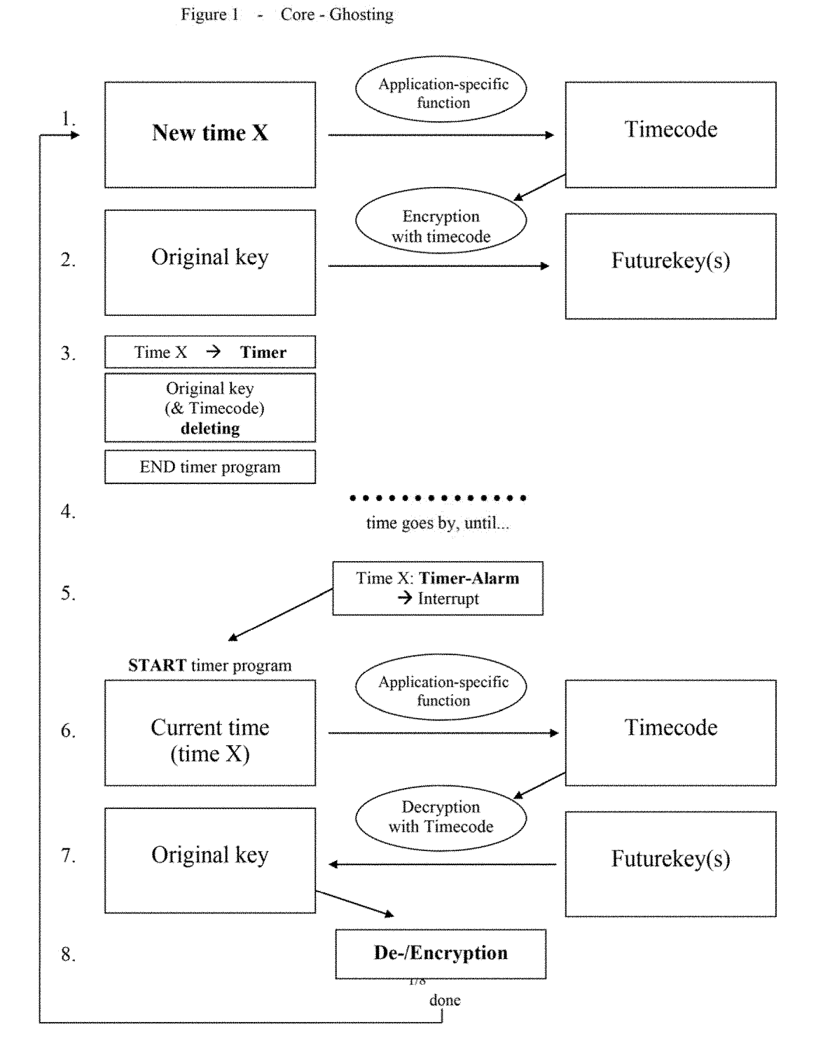

So (see FIG. 1):

1. Future time→(application-specific function)→Time code

2. Original key→(encryption procedure xy with time code as key)→Futurekey (s))

3. Delete the Original key, set the timer, end the timer program

4 . . . system continues to operate normally

5. Time X is reached. Timer→(interrupt)→timer program (again)

6. Time X→time code

7. Futurekey (s)→(decryption method xy with time code as key)→Original key

8. Accumulated de-/encryption tasks are performed and then proceeding to step 1

This means that the Original keys are only available while the timer program is running. As this works exclusively as NMI program, malicious programs are only able to try to capture the key, if the timer program has finished—but by then they have disappeared (encrypted and deleted).

Thus resulting claim 1 of this patent . . . .

### C. DESCRIPTION CLAIM 1 (GHOSTEN)

Method for saving data with multi-layer-protection, in particular log-on data and passwords, wherein

a) from keys used to encrypt data, referred to herein as the Original key, using a time code calculated from a system or alarm time value, referred to herein as time X, in relation to the current system time in the future, one each Key, which is referred to here as Futurekey, is calculated, and

b) subsequently the Original key (s) are deleted, and

c) a timer is programmed and started, so that it runs down or triggers at the time X and thus calls a timer program, which from the then present system time or timer alarm time the time code from a) again generated and thus from the Futurekeys recalculate the Original key used in a) to perform pending decryption and encryption tasks;

d) wherein the method described by a) to c) is repeated continuously and the respective time X, for each of which it is possible to calculate the Original key from the respective Futurekeys, is always programmed directly into a timer and stored information about this time X including the time code are deleted from all storage media except the timer;

e) wherein decryption and encryption tasks are cached until the next time X and then perform and process these tasks at time X by the above mentioned timer program. (FIG. 1)

1. Original Key

Basically, original keys are understood as cryptological or cryptographic keys as they are used to encrypt or decrypt data, i.e. to convert from plaintext to ciphertext or vice versa, whilst symmetrical keys/encryptions are mainly considered here—although the method is also useable for asymmetrical keys. Now, these keys are not being stored or hidden somewhere in the computer system, on which the respective encryption software is running, nor elsewhere stored or hidden—but are being itself encrypted symmetrically !! (for example, with AES-192, with high (possibly the highest possible) number of rounds, at least 16) encrypted. The result of this (Original) key encryption is called Futurekey

2. Time Code, Time X and Formula

For this Original key encryption, a time code is used as a key. This time code is generated from a future system time value with the aid of a preferably application-specific function—formula. For this purpose, from an application-specific rough period of time (for example 2.5 sec.) and a likewise application-specific minimum time, using a random number, this future system time value (time X) is determined. By using the random value within a period which is limited both ways, up and down—it receives a certain variability and is thus unpredictable. The likewise application-specific formula for this could be simplified look like this for example:

Time X=Current time+time span minimum+(time span maximum−time span minimum)*random number from 1e12/1e12.

The time code should have a length that is contemporary for a key. Presently it should be at least at 128 bits. However, at least 192 bits are recommended. Since the system time usually is a maximum of 64-bit value and without date and with a time resolution of 1 microsecond (1 millionth of a second) even only 37 bits are sufficient, it requires an application-specific formula to generate a e.g. 192-bit timecode from time X. The length of the time code can be fixed or variable within a certain frame. As mentioned, 128 bits should be considered as the lower limit.

3. Secure Delete

Immediately after a futurekey has been calculated, the associated source key (Original key) is deleted. If the document refers to “deleted” or “safely deleted”, it always means “secure deleted” Secure deleted” means here and in the entire document, not only pointers/notes/validation marks etc. are deleted, but the memory used for the respective content is repeatedly overwritten with different values. For this, at least the NSA standard DoD-5220.22-M (ECE) should be used. It must be ensured that the Original keys are securely deleted in all media, even in remote computers, main memory, hard disks, caches, paging files, etc.

Handling for technical emergencies will be discussed later.

As a result, the keys used to encrypt data (Original key)—the Achilles heel of any encryption—only exist in secure encrypted form as Futurekeys.

Now the key used to generate the Futurekeys, the time code, must be destroyed. It must also be safely deleted.

4. Timer—Minimum Requirement

Before all memories and notes of the time X are safely deleted, they must be programmed into a timer (see also claim 2) and this timer must be started. Then time X is also safely deleted. Now only the timer “knows” at what time from the then present system time value or the alarm time, the time code can be reconstructed in order to decrypt the Original keys from the Futurekeys.

It is essential that the programmed value in the timer (time X), which is either the start value of a timer, running or counting back to 0—or the value of an alarm time, and any time register, can not be read or is disabled against reading until the alarm time or zero time (countdown) is reached. If the standard timer of the computer system (on which a software is to work according to the method described here) cannot ensure this, the timer hardware extension described later must be used, since a malware could otherwise read the time X from the timer and thus—knowing the application-specific formula—calculate the time code and thus decrypt the Futurekeys. The explanations in chapters D. (Description CLAIM 2 (timer hardware extension)), J. (error correction when starting the timer program), K.2. (Low timer resolution and key width), K.4.a) (128 bit timer registers) must be observed.

5. Interrupt/NMI

All of this (Time X—Time Code, Original Key—Futurekeys, Deleting, Set Timer) will be applied at the start of the system and otherwise at the end of the so-called timer program. This timer program is called as soon as the timer expires or triggers an alarm and thus triggers an interrupt, which in turn interrupts the running programs (whatever) and calls the timer program, which was entered in the interrupt jump table. For this purpose, a so-called NMI (Not Maskable Interrupt) should be used, whose immediate execution can not be prevented. (see also claim 2)

At the beginning of the timer program, the current system time or the alarm time of the timer is using the mentioned above application-specific function to (re-)calculate the time code. This now serves as a key to decipher the respective Original key from the Futurekey (s).

6. Task Cache

All the deciphering and enciphering of data requested by other programs, servers, clients, etc. in the meantime (i.e. the time from the last termination of the timer program to its renewed call by the timer event interrupt) has been buffered/cached. This cache can be a kind of database, a simple file or a kind of stack, like the processor manages one.

In any case, it must be ensured that this buffer can not be manipulated. Due to the short validity of this buffer, e.g. an asymmetric encryption in conjunction with hash test values and certificates could be the appropriate tool. The information under K.3 (interface communication) must be observed. Optimal would be the method used for passwords according to G.3 although of course no hashing can be used for normal data. It will ultimately be a matter of performance. But it should be remembered It does not help much if the data from the entry into the present process are bombproof, but can be attacked on the way there at any time.

A good alternative would be to cache the tasks on the timer hardware extension. This can protect itself much better against manipulation and ensure that really only the timer program receives the list of tasks.

7. Login Informations Never Will be Decrypted

The requested and buffered decypherings and ciphers are now being executed by the timer program, whereby decoding of Login informations/credentials is categorically prevented. This is ensured by the program via encrypting the different columns of a database (arithmetic processing of the Masterkey) in different ways, so that a manipulation, such an SQL attack conceivable exchange of database columns, is excluded. Also, the timer program can always detect when it comes to credentials, or after such a swap, the intended deciphering fails, because the arithmetic change of the Masterkey due to number of the database column, as well as data from the preceding and following columns, then do not lead to the matching Masterkey for this column.

After completion of the accumulated decipherings and ciphers the exit of the timer program is initiated, which starts the procedures described at the beginning such as setting a new time X, calculating time code from it and thus encrypting the Original keys to Futurekeys, setting timer as well as deleting source key, time code and time X, etc. means. (Pos. 1 to 3 of FIG. 1) The process is therefore repeated. Since the original keys are no longer available and until further notice there is no key with which you could decrypt the Futurekeys back to Original keys, but the Original keys are then suddenly unpredictably back again from the outside (time X) back again, the inventor calls this Disappearance of the original keys “ghosting”. (see FIG. 1))

The concomitant delay of the login by the fact that on average only in about 1.5 seconds, the credentials are checked, is (especially in Internet traffic) not significant because it occurs for each user only once upon login. If further data is encrypted with the procedure and must be accessed again and again, then the interval specification may be shorter (for example 0.2 sec.).

### D. DESCRIPTION CLAIM !: (TIMER HARDWARE EXTENSION)

Method of Claim 1, wherein

the timer used from method step c) to d) of claim 1 is housed on an additional hardware, the timer hardware extension and—after the start of the timer—cannot at all be read until its expiration/triggering, and thereafter, can only be read once!

1. Timer (Basics)

A timer is a software or hardware realized/implemented device that provides time related functions such as clock, alarm time, counter, stop function and countdown. The minimum function required in claim 1 is the so-called countdown function. Here, a certain time is specified and the timer counts back to zero. Then the timer gives an alarm signal, which is meant in the definition of the claims with “expiration” (or “running down/back to zero”). Another variant is the alarm function. At least 2 registers are necessary for this. In the time/count register, a time, e.g. the current time is specified/is running. The alarm signal is triggered as soon as the time register has reached the time entered in the alarm register. This is meant in the claims with “triggering”

Both variants are conceivable within the meaning of the invention, but only the alarm function provides 100% security and is thus the one that is to be assumed in the entire document in the first place. The countdown option is included only for the sake of completeness for systems that cannot provide the alarm function.

2. Interrupts/NMI

In most computer systems, hardware timers are integrated into existing chips as electronic timer devices or timer components. The alarm signal is usually connected to an interrupt input of the CPU so that the alarm function can be executed in a timely manner. If a CPU receives an interrupt, the execution of the running programs is interrupted. Program counters and CPU registers are stored in the stack and the CPU calls the program that is entered in the assigned interrupt jump table. In the process, it is first determined which interrupt it is and the matching program will be started. Most systems have 16 distinguishable interrupts. In addition, all systems known to the inventor provide a special interrupt: The Not Maskabel Interrupt (NMI). This can not be prevented in contrast to the normal interrupts. It has the highest priority. At the end of the interrupt program, the CPU registers are taken back from the stack and the program which was originally running is continued. This results in some special requirements for interrupt programs but is not important at this point.

The important thing is that the alarm output of the timer is connected to the NMI (or at the worst to interrupt) of the system and the NMI jump reference or the corresponding entry in the interrupt jump table points to the timer program and is checked and ensured by various sides that this entry is not manipulated. (see in particular N. claim 9)

3. Register Size and Time Resolution

Timers are available in various designs. PC timers have usually a size of 32 to 64 bits. That means the time, alarm, countdown time are each 32 or 64 bit registers. Often there is the following layout: hhmmssHH—Where each letter stands for one byte. 2 bytes for hours: hh, 2 bytes for minutes: mm, 2 bytes for seconds: ss, 2 bytes for 1/100ths of a second: HH. 8 bytes correspond to 64 bits. Sometimes there is another 64-bit register for the date in YYYYMMDD format.

But there are also many timers that are simply built as a meter clocked in milliseconds or microseconds. A 32-bit register could therefore count 2̂32=4.2e9 milliseconds. So could be counted up to 1193 hours which is enough for a day. For resolution in microseconds, at least 11 digits are needed, which requires at least 37 bits. While there are some 48-bit exotics, most are 64-bit. The date is also simply a number, whilst our calendar will work with a 6-digit number of days for long. So you could split a 64-bit register in 24 bits for days and 40 bits for microseconds and would work fine until the year 45964.

We need at least 1 of the 128-bit register or 2 of them (one for the current time and one for the alarm time) for a really secure procedure. 64-bit still works, but does not stand up to certain very unlikely attack scenarios of the future. (see Attack Scenarios, Low Timer Resolution, and Key Width+Technological progress) It is also desirable to have a higher time resolution than microseconds. A clock at 1 GHz already counts picoseconds. Faster ones are not known to the inventor, but might exist. The structure of the timer registers, however, does not matter. The important thing is that they can both be set arbitrarily, which means, for a safe procedure, we use an alarm time timer. A countdown timer would have to provide a resolution (smallest time unit) of 1e-40 seconds and is thus completely unrealistic.

4. Timer Hardware-Extension

99% of the standard timers in PC systems offer the above mentioned time function and one or more alarm function (s), but some of the features relevant to the invention cannot be used with such. In addition, they often only offer a resolution of 1 millisecond. For this reason, an additional hardware timer is part of the invention. This is required to realize the highest security level of this data protection system. It can be accommodated on a plug-in—expansion card as they are also common for other hardware expansions of classic PC systems and are connected via a bus system to the motherboard. Common today are so-called. PCI cards, with a connection—if possible—with the internal bus is preferable. Also conceivable would be a kind of piggyback system in which an existing chip is replaced by an extension which simulates this replaced chip but at the same time connects other components with the internal bus. Future systems could already have it on the motherboard, or it is housed in another chip.

For the invention, it is only relevant that the services shown below are available. It would also be possible to implement the 128-bit timer by concatenating 2 64-bit timers.

5. Read Control

The most important feature of the timer is that it can not be read until it has expired (countdown at 0) or alarm triggered (alarm time reached). This applies to the alarm time register as well as to the time register (or countdown register if used a countdown timer).

a) Read Lock Until Alarm

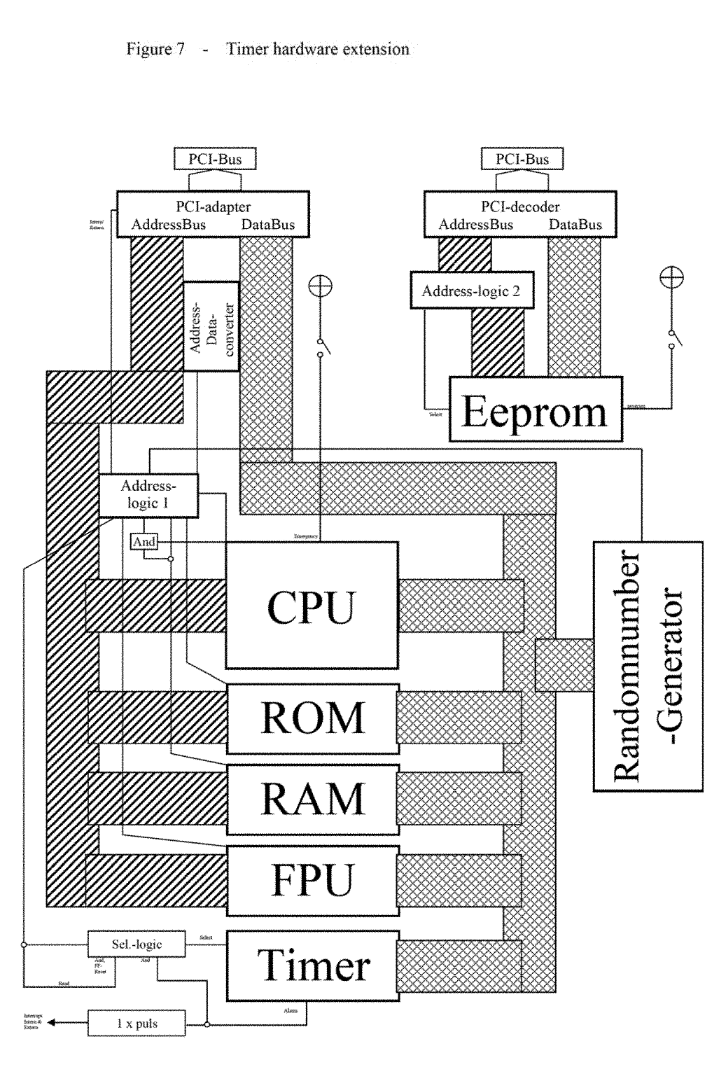

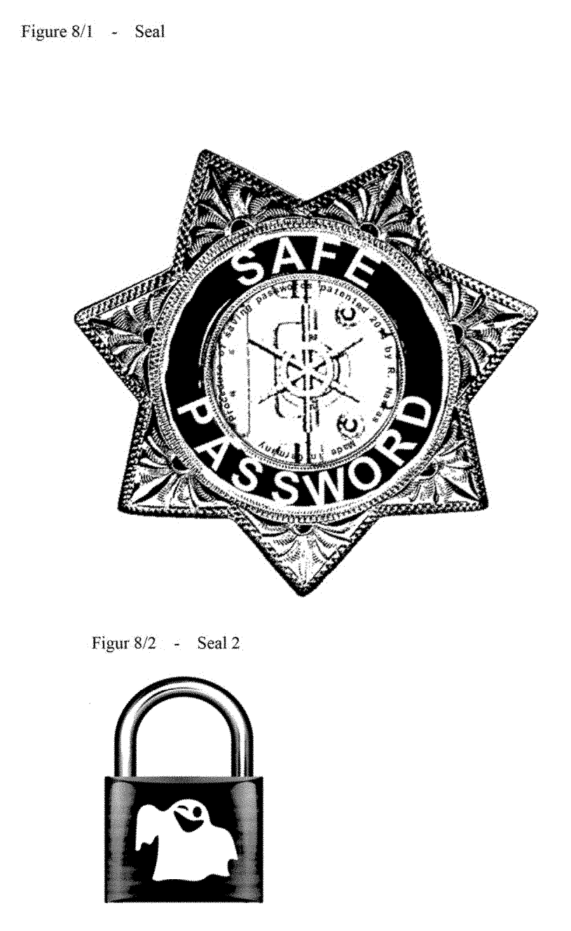

This must be ensured on the hardware side so that manipulation/modification (especially software-side) is impossible. This would be possible in the simplest sense by decoupling the read select signal of the timer as long as the alarm signal is inactive. The alarm signal reconnects the read signal so that it can reach the timer. But already with the first arrival of a read signal, the decoupling becomes active again, so that further readings are only possible after a renewed alarm triggering, which realizes the following feature. (FIG. 7)

In the further course of this description, further features of a potential (timer) hardware extension are presented. It will therefore make sense to build this hardware with a microcontroller with the signal control all possibilities are open, as well as the control of readability.

b) One-Time Info/Running after

The second most important feature is to ensure that after the alarm event, the timer (its alarm register) can be read once. This is necessary in order to provide the timer program with the time X (the set alarm time with which the timer program can restore the time code) or the delay since time X. However, this may only be possible once so that no other program (as the timer program) or any other hardware can retrieve this sensitive information.

In the case of a countdown timer, it must continue to run (maybe to the minus) after the alarm event (timer has reached 0) until it is read.

This is part of the error correction at the beginning of the timer program (see chapter J).

c) Manipulation Alarm in Case of Unauthorized Reading

In addition, the timer should be able to trigger a system alarm when before the timer alarm event an attempted is made to read the timer, or an attempt is made to read the timer a second time (after the alarm event). System alarm could be put into realisation via another interrupt with another ID or via a stop signal. Also, the connection to a sound generator or such on the hardware extension would be helpful. On the hardware side, this could be realized with a simple AND logic between “read select uncoupled” and “read select input”.

Thus, it would be recognized immediately that a malicious program in the system is working and trying to do some trouble.

It is questionable whether it would be advantageous if in addition the writing of the timer should be allowed to be programmed only after it has expired. This would at least for the very first setting under circumstances problematic, but most of all, data protection can not be undermined by an illegal programming of the timer. If the timer is manipulated, it gives an alarm at a time other than time X. The result would be that the timer program does not determine the correct time code and the decryption of the Futurekeys fails or yields incorrect results. Nevertheless, it should be evaluated as a sign of an unauthorized manipulation attempt.

6. Transfer Encoding

Thus, the timer can only be read once per phase (start—alarm/trigger). In the case of a countdown timer, this will continue after the countdown until it has been read out. The read follow-up time in connection with the system time or the alarm time is thus known only to the timer and the timer program and can be used to arithmetically alter and/or encrypt the timer time to be set. Thus, this new time X can not be intercepted otherwise or would be useless.

On a microcontroller card as a timer hardware extension an encryption could be done with a corresponding chip or programmatically. Without a microcontroller arithmetic processing would be the most useful solution. Since only about 3 seconds remain until the next timer phase, a high-quality arithmetic processing should probably be hard to crack, especially since the alarm-time variant anyway only use pseudo-random times as a basis.

The type of arithmetic processing can be coded in the first bits or bytes of the alarm time, the timer time or the system time minus the follow-up time, so that not only the parameters of an arithmetic processing, but also the arithmetic operations or types vary.

As an additional security measure, the timer hardware extension can cause an alarm, if not being upstarted again within a certain time (roughly the amount of time given to the timer program for working out the added tasks) after the alarm was caused. This would show, that there is a serious problem.

### E. DESCRIPTION CLAIM : (RAM-MATRIX—HIDING-PLACE ORIGINAL KEY

Method according to one of the preceding claims, wherein any cryptographic keys, in particular in step c) of claim 1 recalculated Original keys, when stored in main memory, or other storage, as might be the case during their use for decryption and ciphering tasks of the timer program, either is split into a memory area of random numbers, the random matrix, are kept hidden, wherein the pointers to them being stored thereon exclusively in processor registers, or the keys themselves are stored exclusively in processor registers; wherein the memory area for the random matrix is to be filled with new random numbers each time before keys are hidden therein.

1. Problem Multithreading

Modern systems are designed so that multiple threads (programs, program parts, tasks, services, etc.) run simultaneously. Often, “at the same time” means only that the processor allocates its resources and distributes them among the different threads according to their priority. However, in the age of multi-core CPUs, threads are actually running at the same time, at least as far as possible, because access to RAM, etc. is of course only possible with one thread at a time, which is why the processor cache is important in this regard.

Although a large part of modern operating systems prohibits an overlap of the main memory between different threads, it is always conceivable that a thread will find ways to circumvent such limitations. It is therefore not inconceivable that a malicious thread will be able to access and thus capture the memory area used by the timer program, in which data as well as the decrypted Futurekeys (the Original keys) are located. Of course, this must necessarily be thwarted.

Actually, the system should be set up in such a way that it is possible to run the timer program completely exclusively, which means there are no other programs in the whole system running in parallel (at the same time) to the timer program. There are systems in which an interrupt, especially an NMI, runs exclusively anyway. If not, the timer program at the beginning must disable all other threads of the system, as well as all other interrupts. The system should be adjusted accordingly. In the event that this is not possible or the attacker finds a way around these limitations, the present invention uses a

2. Memory Random Matrix

For this purpose, the keys to be protected, such as the Original keys (we essentially go from 2, Masterkey/Timekey, see also below) split into several (at least 8 better 16) parts, stored at constantly different locations within a memory random matrix. For this purpose, at the beginning of the timer program, a larger (e.g. 16 MB in a 64-bit system) protected memory area filled with (eg 1 million (different) 128-bit) random numbers and randomly determined where in this area exactly the key is stored, it is never stored as a whole but in preferably 16 parts split and the position of each of these parts (within certain limits) is determined by random number.

If the checksum hash shown in point G. 1. (error correction, when using a countdown timer) is used, the random numbers must be selected so that 80% of all random number combinations that yield the same bit length of the key to be hidden (eg 128 bits) at least once, better several times (depending on the order) result in the 16-bit hash checksum noted for error correction.

For example, a 128-bit key is hidden in 16 parts in a 16 MB (megabyte) memory area. The assumed 16-bit checksum hash of the key is $ A7. Thus, initially a set of byte numbers (8 bits=128 bits/16 parts) are formed in 80% of all possible 128-bit combinations (no matter in which order one puts them together to a 128-bit number) results in the checksum-Hash $ A7. Now about ¼ of the memory area is randomly filled with 8-bit values of this set. Then, 128-bit values are randomly generated and discarded until they yield the same 16-bit checksum hash of the key ($ A7). Only those are then split into 16 parts and randomly written to the memory area.

Thereafter, the actual key (Original key) is also written in that memory area.

If two keys need to be hidden, it will be easier to do because the randomly generated values can each result two checksum bash values. The subset is thus doubled.

In the matrix exemplified here, in the case of a brute-force attack, there would be about 1e115 different combinations for a 128-bit key. This corresponds to 2̂382 possibilities. This is of course enough for the short time in which this matrix exists and even in the event that an attacker loot the matrix completely and then in “peace of mind” all possibilities could be counted by. Even if the contents of the main memory including the matrix AND the whole database are captured, the security is still enough for the next 300 years (see technical progress). Well, and 2 hidden keys bring already 2e230 possibilities anyway. Since then just the direct brute-forcing of 2 128-bit keys with a total of 1e77 options would make more sense. This also means: For 2 64-bit pointers, a 3 MB memory matrix is sufficient. Pointer size and matrix size are directly proportional to each other.

As already shown at the beginning of this description, the best hiding place, however, does not help if someone can find the hiding-point, i.e. the pointer.

Therefore, the pointers pointing to e.g. 2 such hidden keys or their e.g. 16 parts must be encoded into two (one each) QWords (64-bit), using an application-specific algorithm. With a split into 8 parts a single QWord is enough. This algorithm contains several random values, which makes it difficult to calculate the respective position so that at least the then captured Timekey (see later) should have been invalidated long ago. However, it must be clear: Two 64-bit pointers hold 2̂128 bit possibilities. So if someone knows the application-specific algorithm that codes the pointers, the mentioned above Possibilities will be reduced from 1e77 to 3e38. So if somebody actually has captured the matrix AND the entire database and has the resources to attacked with e.g. 10 PetaFlops (the 10th fastest supercomputer in the world), it may still take billions of years today, but in 50 years it could just be encrypted in about a week. Ergo: For data that should be protected for more than 50 years, a computer or processor architecture must be selected which can accommodate 2 128-bit pointers in the processor register. By the way, then the whole effort with the matrix is unnecessary because then you could store the protected keys (so these are not more than 128 bits) directly in the processor registers. Why are these processor registers so crucial? This is because you can not access it, even from other threads/cores. The registers would only be stored in the stack in the event of an interrupt (which is the timer program itself and therefore does not matter here) but otherwise there is the possibility for the outside world to get them only in the case of a so-called processor dump. With a dump, the computer saves the entire contents of the processor and mostly specific areas of the RAM to hard disk and stops the system or performs a reset/restart. This usually happens in the event of a fatal error that makes it impossible for the CPU to continue executing the system. Since this is a serious attack scenario, it is important to disable the possibility of such a processor dump.

Apart from the processor registers, only the processor stack is allowed as a temporary cache for one of the QWord pointers, which should then be encrypted beforehand with the other key (the key pointed to by the other QWord) or with the help of the timer hardware extension. However, for performance reasons, it would be better to arithmetically change this pointer, at least with the other pointer (which remains in the processor register) or the associated key, which is not as complex as encryption, but has a comparatively high and acceptable security for the short term.

With appropriate design of the timer hardware extension, a pointer can also be cached on this.

The memory area for the memory random matrix can be chosen generously. 16 MB would be more than sufficient. Essentially, the size is limited only by the need to be able to store the pointers only in processor registers. As a result, they cannot be very large in many systems because of the limited number and size of registers. However, you should always choose the largest possible memory for the random matrix. If there are enough registers available to store the pointers, then these possibilities should also be used and e.g. 16 MB for the random matrix should be taken.

However, the performance must also be considered, because of course it takes more time to fill 128 MB with random numbers than just 16 MB. And note that this Random Number Population must be recreated each time the Timer Program starts, that is, before each key is stored in it (approximately every 3 seconds). Otherwise, an attacker would only need to compare one matrix with the other and could tell from the changes where the keys were hidden.

In the end an enlargement of the matrix is only of any result, if many more possibilities arise from it, than from the decoding of the pointers.

Alternatively, instead of storing Masterkey and Timekey, only the time code can be hidden in the matrix, if the computing power allows the respective Original keys (Masterkey and Timekey) to be calculated from the Futurekeys using the time code immediately before each decryption of data these are used for. For performance reasons, however, this design hardly comes into consideration.

A security-enhancing supplement can be realized by using a very slow (reading) memory for the matrix and thus a complete capture within the validity of the in place hidden keys is already excluded via hardware technology. (See O.7 Flash/RAM Memory)

### F. DESCRIPTION CLAIM 4: (DATA PROTECTION SYSTEM)

Method according to one of the preceding claims, wherein

for the protection of data they are sequentially encrypted with at least 2 different Original keys, each with different encryption methods, wherein

a) one of these Original keys, the Masterkey, each time before it is used to encrypt data, is edited so that this can be reconstructed for decryption again and yet as possible, each encryption is done with a slightly different Masterkey and

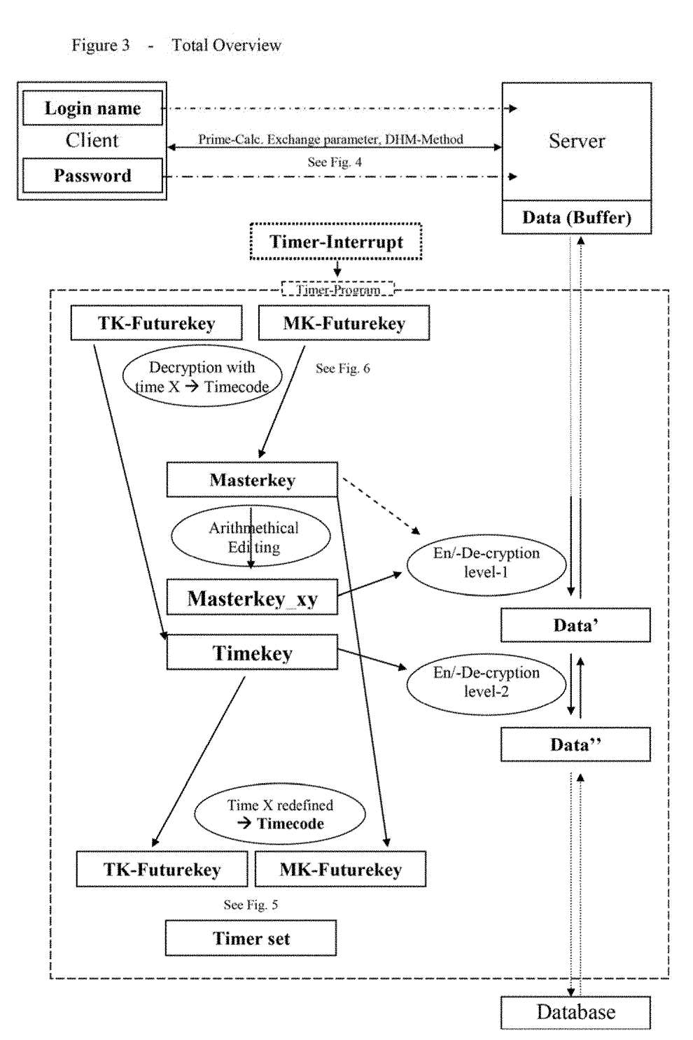

b) another Original key, the Timekey is generated again and again at certain intervals, in which case each encrypted data with the previous Timekey is decrypted and immediately re-encrypted with the newly generated Timekey, so that rotating ciphertext are generated. (FIG. 3)

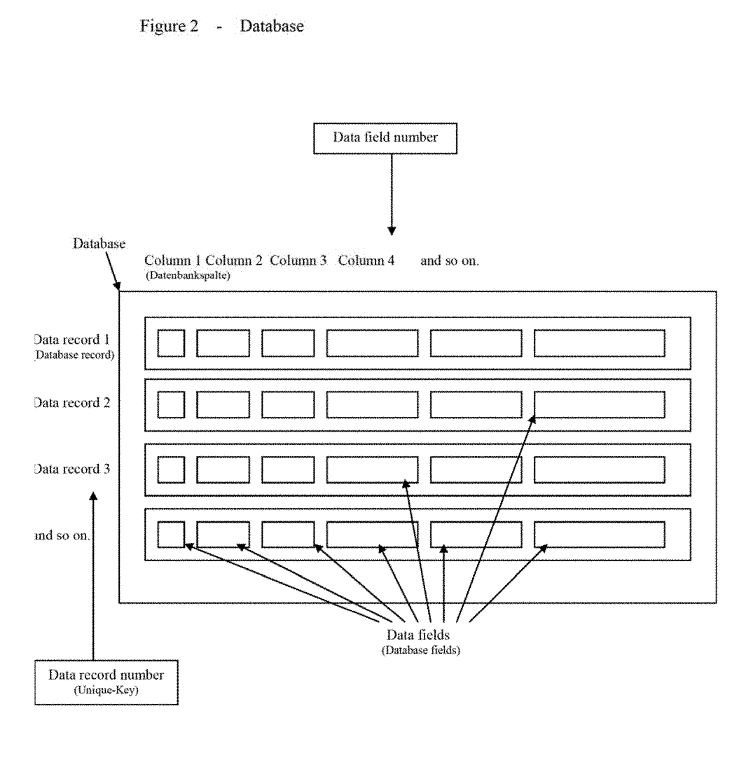

As an Original key, in analogue to the previous claims, any cryptographic key that can be used to encrypt (protect) data is also understood here. The protection of data includes here their multiple encryption to protect them from unauthorized access. If here and in the following data is mentioned, then this means any kind of data as they are mostly managed in databases (terminology see FIG. 2). In particular, credentials, so login names and passwords. Therefore, the method procedure is here represented by a database to be protected.

The Method can basically be applied with an unlimited number of keys, but here and throughout this description we always use 2 keys, one of which is called Masterkey and the other Timekey. (See FIG. 3) They should each have a length of at least 128 bits. However, it is recommended—especially for data that should still be safe in 50 years, to use at least 192-bit keys and for particularly sensitive data 256-bit keys or longer. Since due to the structure of the entire Method in an attack ultimately only the brute-force method is likely to come into action here, most likely: The longer the safer.

In the presently adopted embodiment, data to be protected or hashed login data is first encrypted with a Masterkey modified according to the data column or data field, and then with a time-varying Timekey.

1. Masterkey

The Masterkey is intended as an application-specific and almost unique key. Before it is used to encrypt data, it is (arithmetically) processed or changed as far as possible. This processing is carried out with an application-specific formula based on organizational data and/or other data of the respective database set. (Pos. 5, FIG. 3)

a) Arithmetic Processing

Bases of this formula may e.g. the so-called unique key (unique ordinal number/numbering of each data record) and/or a data field number and/or other data which change depending on the encrypted data field, and/or other data of the respective database set (e.g. login name, clear name or date of birth) or a greatly reduced (checksum) hash value thereof. Unfavorable are the respective ciphertext, because the encryption can change to it (see Timekey). Well suited is e.g. the plaintext of the login name or its masterkey encrypted ciphertext, which is encrypted as the most important search data field with the unprocessed Masterkey, or only column sensitive, otherwise a search query to the database would be impossible or at least very time consuming. In addition, for each data column to be encrypted, a slightly different formula should be used for processing the Masterkey, and the data of other data fields of the same data record should be included, so that manipulations by exchanging the data fields or columns do not lead to a valid decryption.

Ultimately, it is crucial that the respective database-related parameters for the processing of the Masterkey are again available in the same way if the respective data is to be decrypted again. It must therefore be ensured that no paradoxes arise.

Thus, almost any encryption performed with the masterkey is done with a slightly different masterkey, and it is not necessary to separately control or ensure this. However, the formula should be chosen so that a multiple occurrence of the same Masterkey is unlikely.

An example of such a formula can be found under point I 3.

If you want to search for data in an encrypted database, the value to be searched for is also encrypted and the result then compared with the already encrypted values in the database or sorted out (or the hash values thereof). For this reason, a database search will not work if the data is e.g. be encrypted differently with each record. “As far as possible” (paragraph 1 under 1. Masterkey), or “if possible” in the claim definition, refers precisely to the fact that the arithmetic processing of the Masterkey is only possible for data fields or data columns in which a database search is not necessary. Column-sensitive processing remains possible, but within the column, the Masterkey must always be processed the same or the same Masterkey always be used. A processing of the Masterkey that changes the respective Masterkey′ with each data record can only be carried out for data columns to which a database search can be dispensed with.

b) Emerging of the Masterkeys

In contrast to the algorithm used, this Masterkey must be secret and therefore individual to the respective application. It can e.g. during the installation process (of the software for this method) from a program serial number or from the hardware data of the PC (including various serial numbers and processor IDs) or from e.g. 58-digit random number may be generated in combination with a unique key implemented in the program code. It is conceivable that the application or the user can be assigned by the manufacturer or its registration server during registration or after installation. A generation from a hardware component (hardware extension according to claim 2, 8, 9) for the generation of keys/random numbers or with the help of random mouse movements of the user would be practicable. Ultimately, it will probably be a combination of these methods.

In practice, there will probably be at least two Masterkeys per system—one being used for the data fields which, for reasons of data search/searchability, are not encrypted with changed Masterkeys—and one for all others.

c) Masterkey Storage

The masterkey is converted into a futurekey immediately after its generation using the same function as the timer program for the Original key (like the masterkey one is), with the time to time X once after installation is becoming clearly longer then during running operation. Likewise, the masterkey is then safely deleted and the timer is set for the first time.

This means that the masterkey itself is no longer existent. Only in encrypted form as a Futurekey where even the key (time code) used for this is also deleted. The Masterkey is “ghosted” (see chapter C). On the other hand, this means it has to be backed up separately in the event of a hardware failure/system crash. Please see point T. Backup.

2. Timekey

After encryption with the (processed) Masterkey, a second encryption with the Timekey takes place.

a) Encryption Method

The encryption method to be used here must differ as clearly as possible from the method used with the Masterkey. For example, from today's perspective, AES encryption would be an option for the Masterkey; i.e. e.g. AES-192 with the highest possible round number, at least 12, better 16 and for the time code e.g. Twofish or Blowfish.

However, the present protection method is fundamentally independent of the cryptological encryption methods used therein. This should be adapted as time and technology progresses, so that in each case those are used which are considered to be safe (and future-proof) or the most secure at the respective time. The same applies to the key width. Depending on the sensitivity of the data, the minimum size may be any of 128 bits, e.g. be increased to 192, 256, 512, 1024 bits or more. Ultimately, it's just a question of computing power.

b) Time Span

The Timekey is the key that is renewed in fairly regular intervals by the privacy program, here the timer program.

For this the key contains a hidden rough indication of when it was created. For example, Hour and 10-minute, which is to accommodate in one byte. This way, the timer program can decide for itself on each run when it initiates a renewal.

Similar to the time intervals for time X, which are variable within certain limits, a rough time span is also specified by the user here and then extended by a random component.

Suppose this is 90 minutes, with a variance of +−20 minutes. For example, the timer program, which runs every 3 seconds, generates a random number from 0-600 (40×20) from the moment the Timekey is 70 minutes old. If 1 is the result the renewal of the Timekey is initiated. Statistically, this should happen once in these 600 runs (=40 min.). Of course, since this is not reliable, the timer program will increment the number of counts as progress, e.g. reduce by 10 per minute the Timekey is older than 70 minutes. For example, from 90 minutes of age, only a random number of 0-400, from 120 minutes age of 0-100 and from 129 minutes age of 0-10 would be generated. Since the lower limit is 0-2, the probability of a 1 increases exponentially with increasing age of the Timekey.

The size of the user-specified time span (in the above example 90 min.+−20) depends essentially on the size of the protected database (or the amount of protected data) in relation to the computing power. If this relation is very unfavorable, the rough time span can be set up to 24 hours+−5 hours. Above this is not recommended. The variance should be in the range of 15 to 30% of the coarse time span.

c) Renewal

To renew the Timekey, a new Timekey′ is first generated by means of a non-deterministic, cryptographically secure random number. (See point K.1 Random numbers) This must be unpredictable and uninfluenced. It goes without saying that if necessary, by multiple generation from a smaller random number one e.g. 128-bit key is assembled together.

Now all encrypted with the previous Timekey ciphertext is decrypted piece by piece and immediately with the new Timekey′ encrypted until all data with the Timekey′ are encrypted. Then the old Timekey is safely deleted and from now on only the new Timekey′ is valid as a valid Timekey.

It is quite conceivable that for performance reasons this could also be done in stages, whereby when applied to a database, so that no inconsistency occurs, then first the new secret texts from Timekey′ are entered into new database columns and the old ciphertext first still remain. Only when the database is completely re-encrypted, the respective columns are exchanged, which is quite fast in relational databases. Then the old secret texts are deleted and also the old Timekey.

The concept of a regularly changing key is generally nothing new. There may therefore also be other methods suitable for this (conversion).

A rough indication of the creation date/time is added to the Timekey (see b). The specified key size should not be exceeded.

Formation and storage is otherwise analogous to the Masterkey, with the emergence (first generation after installation or after a system restart) simply a non-deterministic cryptographic random number (see c) is generated in an appropriate size.

### G. DESCRIPTION CLAIM 5: (HASHING & ENCRYPTION OF PASSWORDS)

Method according to one of the preceding claims, wherein

for the extended protection of passwords and/or login names, these are converted already during or immediately after the input, with a cryptologic one-way hashing into hash values, which partly or completely mutually serve as encryption key and are partly shortened/compressed and during transmission, in addition to any transport encryption such as HTTPS, by at least one other secret key and at least one sent by the recipient of the password code, the on both sides, so client and server, known password hash and/or login used essentially for generating the secret key and/or codes becomes. (FIG. 4)

Credentials (login data) exist regularly and so this is supposed to be assumed here, of a login name and a password. These are subject to a special need for protection, but especially the passwords. Most users use the same credentials and passwords for all or at least several services. A captured password can in extreme cases lead to unauthorized access to all online services of the user, including own cloud, smart home and online banking.

The dangers are roughly on the one hand in the so-called clear text listening/listening to the transmission (live, i.e. possibly encryption was broken) between password-input of client and the server to whose service access should be granted and on the other hand in much simpler recording of such transfer to be able to crack/evaluate later “in peace”. Then there is the danger that the client computer is hijacked (for example, with Trojans, bot, viruses or other malicious programs) to capture the password or key there and do the attack on the server directly to steal the data stored there. A brute-force attack (testing all keys) on the server is to be ruled out because in the meantime the last server application should have installed a timely limit of login attempts.

Overall, it would be fantastic for the attacker to get hold of the password as plain text, which is still happens often enough and is terrifying, but usually they are also satisfied with a password hash. This is then either transferred to the server in simulation of a client or it is tried so that the password or a pseudo-password (which works the same way because it produces the same hash) is used, which is sometimes surprisingly easy and fast.

The intensity of the respective protective mechanisms must be adapted to the potential danger.

1. Password-Hashing—State of the Art

In order to prevent the seizure of a password hash from the database, there is the present method with the previously known and still following steps. In order to completely exclude the theft of the password in plain text, as part of the present method, as defined in claim 5, plaintext passwords never completely permanently stored. Also not “only” encrypted. Rather, passwords such as those entered e.g. upon registration (first time login) to e.g. a web site or a web server, or entered at the dialog box of an application such as a database application or an e-mail client), if possible immediately, i.e. from the browser/front-end/dialog box directly, with or at the latest after their input, but at the latest by the web server after their secure transfer there, via cryptological one-way hashings (OWHF) and then a part thereof by checksum hashing in (total) 25% shortened HASH VALUES converted so that the passwords can not be reconstructed. Only these hash values are stored (encrypted). Of course, what is used within the present method with repeated (2-fold) encryption, as described already up to here and in particular in claim 4 and shown below, happens protected. All memory residues from the plaintext password and its entry are safely deleted. (OWHF means one-way hash function and stands for the creation of a hash value from which even if the used method/algorithm/key is known, a restoration of the initial value (input value, here the password) is impossible.)

For subsequent password entries (subsequent logon)—except for the eventual saving—the same procedure is used and then only the newly generated hash is compared with that stored in the database (possibly after its decryption).

This is actually state of the art and should be used by every service that asks for passwords. It is listed here because it is part of the overall concept of this privacy policy, but above all because it is the basis for the following extensions, which were developed around the previously given—but already broken—state-of-the-art data protection.

The encryption or hashing of a passwords alone is not enough to be absolutely sure that it can not be captured. This includes an overall concept, which begins directly with the input, continues with the transmission and then ends in the (again encrypted) storage. And, not only considering the possibilities given today.

For this reason, the present invention also provides solutions for
the correct encryption of passwords,
the secure transmission of passwords and
the secure entry of passwords.

2. Encryption of Passwords

As mentioned, hashing of passwords should be standard. There are i.a. the cryptologic hash (especially for passwords) which usually yields result values >=256 bits or the shortening hashen what regularly used to verify data transmissions.

This shortening has the advantage that information is “lost” and therefore even theoretically its not feasible to recalculate the initial value. However, there is always the possibility to guess this output value or to try all possible inputs until a value has been found which gives the same hash value. This is called the dictionary or brute force attack. And so we are already at the big disadvantage of a shortened hash value: It does not take much time to find a pseudo-password, which provides the same result hash with the possibly known bash method.

So a long hash value, after all? There are cryptological hash functions that are at least as unpredictable as good encryption. Nevertheless,—if you become familiar with the technical progress (see K.4 Technical Progress), you realize that what is still considered safe could be ridiculous in 20 years. Then captured passwords could eventually be found out and that is to be avoided in any case. For this reason, the present invention selects a combination of both. First an expanding hash method is applied and then a part of it is compressed/shortened. (see Pos. 1-3, FIG. 4) More on that later.

Although the password (no matter how it has been hashed) stored sufficiently secure encrypted by the present data protection process so that a theft can be excluded from there, but a password or the hash of it could already be looted on the way to it.

Preventing or complicating this is the subject of the following subchapters.

The problem with all password ciphers: Most users enter too short passwords. But even with a 10-digit password (depending on which special characters are allowed) “only” 80̂10 possibilities arise. That's about 1e19 or 2̂63. A 6-character password offers only 2e11 or 2̂38. The latter is through at a fairly low computing power of 1 ns/pass in 4 minutes. For this reason, the password hash functions, such as bcrypt or scrypt, have been developed which consciously delay the computation of each pass with PC resource-drawer functions. But assuming that it takes about 0.5 seconds to do a normal PC calculation, in 11 years a super computer can do all 2̂38 in 1 hour. Not to mention special code-breaking machines. No real permanent protection! Added to this is the dilemma that most users take on normal words as the basis of their passwords. Assuming a vocabulary of 50,000 words and takes some popular number combinations with it then we are at a source amount of about 1 million combinations. That sounds like a lot at first, but it's nothing for a computer. In addition, there are particularly popular words or combinations. In many cases, a password matching the hash value can be found in less than a second. For this reason, the inventor is also not very convinced of the time-consuming password hash functions such as scrypt or bcrypt. If you put them in such a way that a normal PC needs 1 second per hashing, then a super computer or a large network of normal PCs plays the whole list of probable passwords in less than 1 minute. Such a delay only brings something from a source amount (sum of all calculating possibilities) of greater than 1e13. Whereby every 10 years this value has to increase by 3 powers of ten. Should possibly be captured passwords in 30 years still be safe then it already needs 1e22 possibilities. But there are just not so many potential passwords.

So it must be prevented that a password hash ever gets into the wrong hands, because once it is captured it can be “relatively” easily cracked. Therefore, it must be additionally encrypted. This happens automatically with https connections, but unfortunately these are not free from successful attacks either. Therefore, the present method proceeds according to a double strategy: On the one hand, two additional encryptions are installed as protection against the capture of passwords and, secondly, the capturing of the keys used for this is particularly difficult.

3. Security of Transmission of (Hashed) Passwords

Unfortunately, there is currently no truly secure transmission standard and nobody can say today whether the currently considered largely secure https-procedure (only including all security-relevant innovations/extensions) in the future as safe can be considered. In addition, for some cases “largely safe” is not enough. Through the NSA affair has become known that the NSA succeeded in hooking in https transmissions or listen to such. The present invention therefore also provides solutions to the problems of data transmission and communication.

We assume here that a user on the client PC has entered login name and password. The login name (LN) has already been converted to a standard LN hash with a cryptological and collision-resistant hash function and sent to the server via an https connection. The password has not been sent yet. (Pos. 1, FIG. 3 and Pos. 0, FIG. 4)

The server identifies the user's account using the standard LN hash, which is also stored in the database as a login name. In the present method, this hash must first be encrypted with the unprocessed Masterkey and Timekey, so that the database search can be successful.

In addition, a 512-bit one-way hash value is formed from the login name. This will only be transferred to the server during the first login (registration). For all subsequent registrations, this must not happen anymore because this value as a mutual secret helps to securely transmit the password. (Pos. 0, FIG. 4) The password is immediately filled with self-data to 16 characters and combined with another (relatively simple in terms of effort) hash value from the login name (Pos. 1, FIG. 4) and by cryptological (password) hashing (e.g. bcrypt, scrypt, as long as DHM is unbreakable SHA-3, SHA-256, Whirlpool would be sufficient, but is not recommended in view of further technical progress) into a 256-bit hash. (Pos. 2, FIG. 4). Then the clear text password is safely deleted everywhere, as well as the plain text login name. The 256-bit hash is now split into 2 128-bit hash portions, with the lower 128-bits compressed to 64 bits by truncating hashing (e.g., CRC-64). (Pos. 3, FIG. 4) These 64 bits are now taken as higher order 64 bits of the second (low order) 128 bit hash part and as low 64 bits become a 32 bit IP (high) and a 32 Bit timestamp (low) added to it. So again a complete 256-bit value is created, which we call multicode.

Now within a secure (https-) connection using the Diffie-Hellman-Merkle key exchange (DHM) a common secret key is created, which is now available to the server and the client without having to be transmitted.

DHM is definitely not considered unbreakable. Especially if the basic parameters (prime number, generator) are known (which is usually the case because they are mutually interchanged or for the respective server are widely known) and sized in the order of 300-digit numbers or less, it seems for High performance computer to be easy to find the DHM key. Due to the high effort to create such large (prime) numbers, the same values are often used or a value pair from a given relatively small amount. But also the recreating of e.g. 500-digit prime does not bring much safety gain when it is then sent over a wiretapped line. Of course, the DHM has been developed to create a secret key even though the parameters and the public key may be known, but unfortunately the security is not that high. That's the weak point of this process. The BSI (German Federal Office for Security in Information Technology) therefore recommends using numbers with at least 600 decimal places. But this too is only a matter of time.

a) The Trick with the Secret Prime Number

For this reason—and also to avert the danger of a so-called man-in-the-middle attack—we apply a secret to generating the prime number, which only receivers and transmitters know without being transmitted (and thus wiretapped) recently. The password, or its hash and the so-called generator hash from the login name. (Except of course during the initial registration. But what is the probability that an attack will happen on an account that does not yet exist or is about to be created, and then while the prime number is generated by the server and transmitted to the client, but thus still the security of a high-quality DHM exists, since one can at least double the order of the basic parameters for the registration or can bring an additional security by 2-stage-authentication.) For the production of the prime number the upper (left) 128-Bit part of the password hash is used. (Pos. 4, FIG. 4) The following calculation is used:

MP=400/digits_PWH+digit2_PWH*1.5

Digits_PWH=Number of powers of ten of the password hash. (Could be about 38), Digit2_PWH=2nd decimal place of the password hash (PWH). Then it is executed: PZB=PWĤMP The result (PZB) is a number with 404 to 924 places, from which the next larger or smaller prime number has to be found.

Of course, there are not as many possibilities for this large number as with a fictitious one, because ultimately one can calculate the respective prime number for the resulting password hash during brute force testing, but that also means that cracking the DHM keys does not have to be about 10 prime numbers or even just one (if the https key was broken, you could listen to the basic DHM values), but just about 1.6e15 so about 100 trillion times as much to be tested. And even if you had found the right prime number, the DHM key has not broken yet. For that even the NSA needs 3 million years. Okay, well, you're sure to find a lightening algorithm that it will only take a few thousand years, but until then, the size of the prime number can be adjusted bit by bit as computing power progresses.

The prime number is now known on both sides without having to be transmitted or specified. Then the server transmits part of the generator. Another part could be taken from the information of the server certificate and another part arises from the generator hash already mentioned above. This hash, which is easy to calculate from the login name on the client side and is known (stored) on the server side from the registry, serves as a further secret which only the communication partners know. This generator hash is now encrypted with the 64-bit hash (CRC-64 hash of lower 128-bits of the 256-bit hash of password, extended to 16 bytes, and simply bashed login) formed in pos. 3 FIG. 4, The result, together with the parts of the certificate information and the part transmitted by the server (which is adapted so that the generator fulfills the mathematical requirements for the DHM method) serves as a generator for the DHM method, which can now be executed. The result is a on both sides known but secret key that even a connoisseur can not know and break. (Pos. 4, FIG. 4)

If the calculation of the prime number turns out to be too time-consuming on most systems, the mentioned above procedures should be facilitated, which is still sufficient for such systems and their attack resources. It would also be possible to swap the calculations so that instead of the prime, the client would compute the generator from the 128-bit portion of the password hash and join the prime number out of the 3 parts. The mentioned above Calculation formula must be adjusted accordingly. In addition, switching from DHM to Elliptic Curve base can significantly reduce the number of parameter lengths by a factor of 10 while maintaining the same level of safety.

Alternatively, the server can help. He also has to calculate the prime number himself and could then give the client assistance in finding the right number much faster. For example, a number around which the calculated exponent of the 128-bit hash (MP) must be increased to be much closer to the next prime. If this is a fraction you can get quite close. This value could be further obscured by e.g. must also be added to the numbers 7-12 of the 128-bit hash. In addition, additional relative values could be transmitted to exactly hit the prime without having to test it himself Or a checksum that allows the client to get to the actual prime value after a few attempts. Since the clues are always relative and/or related to the otherwise unknown initial value, they are of little use to an attacker. Nevertheless, such assistance should be transmitted with another asymmetric encryption, as the time frame permits.

This also applies to the following alternative assistance.

This could be done so that the server is about e.g. 10,000 primes in the length of 400-900 decimal places transmitting. This sounds effortful, but it is only 3 MB and nowadays this can be done within 1 second. Then the client only needs to look for the one that is the closest to the number to that one with mentioned above calculation was calculated. Of course, these primes must vary. However, it would be too time-consuming to calculate them each time. The more practical alternative would be to fish them out of a precalculated pool of at least 100 million. For safety reasons, this pool could generate new numbers independently in the background and replace others so a certain change takes place constantly. Of course, this pool should be protected and encrypted accordingly.

b) Multicode—Double Encrypted is Better than Once

Now the server, to which a password shall be transmitted, sends a 128-bit random number to the client, with the newly created DHM secret key encrypted. This is done by the server per login name and IP only e.g. three times within 5 minutes and a maximum of 10 times in one hour, which directly excludes dictionary and brute force attacks on the server (limitation of login attempts).

The client decrypts the 128-bit code (item 5, FIG. 4) with its DHM secret key and immediately encrypts the random number thus obtained with the upper 128-bit of the password hash or multicode and receives a 128-bit Key (pos. 6, FIG. 4) and securely deletes the random number as well as the received 128-bit code. For encryption, AES or another high-quality/secure method can be used.

This 128-bit key now encrypts the multicode generated above. (Pos. 7, FIG. 4) This is necessary to massively complicate an attack on the DHM key. Last but not least, with the secret DHM key (via AES or similar) the encrypted multicode is encrypted one more time and then sent to the server. (Pos. 8, FIG. 4) Since the secret DHM key is to be used only for this one password transmission, it is deleted immediately as well as the 128-bit key.

(The key and hash sizes mentioned here are only examples, but they should not fall below, but they can be enlarged, especially for particularly sensitive data.)

It is important that the encryption of the multicode with the 128-bit key uses a different encryption method than that used for encryption with the DHM key.

The server, in turn, decrypts the multicode first with the secret DHM key and then with the self-generated 128-bit key (from the password hash and the random value sent to it). It then checks to see if IP is correct and the timestamp is within an acceptable range (in terms of now time and in terms of the time of the random number and DHM public key). If so, the upper 192 bits of the multicode are encrypted as a password hash (with Masterkey and Timekey) and compared with the existing encrypted password hash (following login).

By default, the server deletes all send jobs after 5 minutes, including the secret DHM key, so that late or unsolicited multicodes go nowhere.

When registering (initial login), the password hash on the server side is not yet known. Therefore, as already mentioned, the primary value must be transmitted to the client or a known or one of the server's certificate is used. Strong asymmetric encryption (in addition to https encryption) should be used for transmission. The first encryption stage with the multicode (item 7, FIG. 4) then either is eliminated or is performed with the asymmetric key just mentioned.

Even if an attacker via brute-force/dictionary would find the upper 192-bit of the multicode and simulate an IP and generate a valid timestamp, then he still lacks the random number to encrypt the simulated multicode. A simple brute-force fails because he cannot test the result for correctness. Furthermore, for a transfer to the server they would still need the appropriate DI-IM key, but again, the result can only be tested for correctness very effortful (with each time 2̂50 possibility).

Even if an attacker could intercept the communication and crack the https encryption, he would now have to find the secret DHM key to get to the previously sent random value. Now, the brute-force attack could only begin to find a pseudo-password, which results in the 128-bit hash with which the random value encrypted calculate the complete hash. At least you can not calculate it. And—which is one of the most important aspects, it is not possible to pretend to be a client and simply send an intercepted 256-bit hash to the server as like the correct password had just been entered, because it is different every time and requires first a request from the server. However, a simulation is only possible if previously both (https and DHM) encryption were broken, and—what is standard today, the IP to the previous registrations matches or if not, the computer/device ID is right. Otherwise, 2-factor authentication will be required.

The key difference and advantage in this process is
the enormous improvement of the security of the DHM by two secret basic parameters—prime number and generator, and
the double encryption that makes an attack on the DHM impossible because the result can not be easily tested from a relatively small amount of password hashes. For every potential DHM key, all possible password hashes (in the average 80̂8) and login names (in the average 40̂15) must be tried.

Refraction of the DHM key can thus be ruled out.

The attacker would therefore need to calculate the prime number for all possible passwords and the Generator for all possible login names, after cracking https encryption and then try to break the DHM key, which is not yet possible with the recommended key size. But even with only 512 bit key size it would be a computing work of >50 million years assuming you are 7 times as fast as the known successes of the NSA and the login name is known. Otherwise, it will take 1e24 times longer.

So protected passwords should be safe for the next 100 years.

Possibly for re-encrypted transmission of the generator part and the public key of the DHM procedure an asymmetric key could be supplied by the client to the server. But as long as the present Method can not be broken, as it is currently, it should be sufficient.

c) Hashing of the Login Name

It is assumed here that the login name in the respective web application/application is not required in plain text and thus the security of the password transmission by the steps shown in Pos. 0 FIG. 4—as stated above—can be considerably increased. If a plaintext name is required, it would be useful to additionally query such an alias or nickname.

In the present embodiment of the invention, the login name is hashed cryptographically, similar to the password. However, unlike the method for password hashing, this must be collision-resistant. That means, there must not be two input values leading to the same output value. Since the login name is not transferred and saved in plain text, it can increase security in at least two areas:
An additional hash value, generated either by a different key or other method than that for the hash value transmitted to the server, may in addition be used to generate the Generator for the DHM or may be used as a key for its transmission or for encrypting the transmission of the public DHM key or the DHM prime number or informations. The DHM generator is composed of 3 or 4 parts: A fixed part, a part that was transferred from the server to the client, a part that the client took from the certificate of the server and the mentioned above additional hash value.
The login name in plain text or an additional hash value from it, generated either with a different key or other method than that for the hash value that is sent to the server, can be added to the plaintext password (and possibly its extension to 16 characters) or with it multiplied before it is hashed cryptographically as shown above. Thus, a word-book attack is almost impossible or at least massively difficult, even if the multicode hash could be captured decrypted.

Other security measures, such as 2-stage authentication, especially for login attempts via an unknown device, are state of the art and should be taken into account accordingly.

Of course, this extended protection method can not be applied only to passwords. However, since the calculation effort is very high, it will probably be reserved for very sensitive data only. With increasing computing power, however, the procedure must be adjusted as well. In that case, however, an increase in the size of the key or, if necessary, additional interleaving is sufficient, so that e.g. with the first DHM key, only basic values for a second DHM procedure are transferred, or another asymmetric key. You then have to see what protects most efficiently and how it can be used with the given computing power.

Since the elaborately generated DI-IM key is now available, after the transmission of the password, the temptation could be big to encrypt even more data with it. However, it should be kept in mind that this may simplify a crypto-analysis. It would be better to exchange another symmetric key with the DHM key and to delete the DHM key. Thus, a crypto-analysis could break only this new key, but not the DHM-key that protects the password.

4. Entering Passwords

a) Special Input Fields

The particular hashing used (pos. 0-3, FIG. 4) should be applied as early and as natively as possible.

Ideally, the hash function is already integrated in the input field. For this purpose, for example, a separate input field object must be programmed. Although there are already input fields for most systems that disguise the input with asterisks, but this is also about the fact that the input is not cached. This is usually the case and the entered value is passed to the program which called the dialog (-box). Although the given value could now immediately be hashed, but by then it could have already been intercepted. In particular, the message system such as e.g. Windows makes it relatively easy for an attacker to listen in on what happens with other programs. Since, as we have seen above, a hash value does not represent any high security, it should also be encrypted for intra-system transmission, or the mentioned above Method (G. 3) should be largely integrated in the input field object.

b) Special On-Screen Keyboard

Of course, the keystrokes can be intercepted as well and there have been plenty of such attacks. But this can be prevented with an on-screen keyboard. Then there would only be an opportunity for an attacker to capture the contents of the graphics card and to find out by OCR/text recognition which letters/keys were pressed. The effort is already neat, especially since graphic card drivers do not provide such opportunities. This attack can be made more difficult with keyboard characters which are hardly recognizable for OCR. Weak contrasts, size and color change but above all also deformations help. In addition, due to the mouse clicks (coordinates) conclusions can be drawn on the screen keyboard why the keys should not be arranged in the usual keyboard layout but need to change their positions.

A fairly safe alternative is the “magic keyboard”: First, you see a screen keyboard in the usual layout but without specifying letters on the keys. By constantly changing the size of the keyboard, no simple inference can be taken from the mouse-click data. In addition, it would be conceivable that keys “magically” move to a new position when you just hover over it with the mouse and then it would be the corresponding key on the normal keyboard to press. A change in the various representations would make it particularly difficult for an attacker to hack the input.

A kind of combination of both is the input obfuscation method developed as part of this Method . . . .

### H. DESCRIPTION CLAIM 6: (INPUT MASK WITH SECRET MESSAGES)

Method according to one of the preceding claims, wherein

to disguise inputs the input-user of the computer used to receive instructions how he has to modify the upcoming input.

It will be presented to the user e.g. on the screen given various kinds of hints on how to disguise his password. These are randomly selected in type, kind, design and parameters within certain limits. This is that the program constructs sentences independently.

These could, for example, be: “Next key by 3 to the right (or left if that does not work)” or “in the alphabet 5 more (after z to continue counting at a)”. The result is “s” change to a “g” to be pressed and a “u” to be entered from a “p”. Also, arrows, differences in brightness, colors or other hints on an on-screen keyboard could show how the user should disguise his next input. Puzzles and phrases could be incorporated, or clues referring to user data, date, weather or recent events. Examples:
“Move the next letter around the second number of your birthday”
“Subtract of the first digit of today's daytime temperature in the alphabet”
“Next, just enter as many meaningless letters as your first name has letters and then the last letter of your password followed by 3 indiscriminate digits and the penultimate letter of your password”

To complicate that the texts are intercepted somewhere, they could be (partially) transmitted as a picture. In this, certain numbers may also be inserted as an image or as a symbol (instead of a “3” you see a hand showing 3 fingers). Even more effective would be a partial speech output and again a combination such as Audio: “Move the next letter in the alphabet 2 times the number of parts/pictures on which a sign can be seen”.

The texts, images and notes can be issued one after the other but also at once, depending on the preferences of the user.

Entries made by this method are not much more complicated than using an on-screen keyboard with the mouse, but safer. A keystroke recording is therefore totally useless. Even if the input field or the input and their transmission is intercepted to the application, there is no danger, since only the program which queries the password and has given the hints, knows how to make the right thing out of the disguised password again.

There is software that encrypts keystrokes, but this is more of a gag for the gullible because the encryption strength only makes real hackers grin. In addition, there is always the risk of intercepting the keystrokes even before the encryption software gets it, or get hold of the decrypted inputs.

It is therefore essential that everything is a closed system. That the program which should send the password to the server, gives the concealment instructions and calls the input field, which in turn receives the keyboard inputs. Thus, the obfuscated inputs within the same program are virtually unveiled in one program line and immediately hashed in the next. The subsequent commands now overwrite all memory residues immediately of the clear text password (safe delete) and go on with the mentioned above Method for encrypting the password hash until it is sent to the server. At this stage, care must be taken to ensure that multithreading does not pose a risk, because, as discussed in detail above, a one-way hash can not be recalculated but can be found relatively quickly by a e.g. dictionary attack, which is why the hash alone cannot be considered safe, unless the user enters a 20-digit password that has little to do with normal words.

### I. PROCESS OF THE COMPLETE METHOD

Overview

1. Hashing passwords or receiving them hashed

2. Encrypting with Masterkey

3. Editing Masterkey arithmetically

4. Encrypting with Timekey

5. Encrypting the Masterkey and Timekey to Futurekeys
1. First the credentials are entered. These are hashed according to claim 5 and hashed passwords in combination with the hash of the login name, shortened and encrypted multiple times with secret keys. (Pos. 1-2, FIG. 3)
   This ensures that passwords can not be captured and thus can not be used in other applications/websites. Also, therefore, no clear-text password can be reconstructed, which could allow the attacker to recognize the concept that a user uses to generate passwords. And not even if the attacker could break the (HTTPS) transport encryption.
2. Since hash encryption is definitely crackable* and there are other data that are worth protecting, a (e.g. 192-bit) key (Masterkey) must encrypt hash values or other sensitive data (but in contrast to Password must be completely recoverable and therefore can not be hashed). (Pos. 6, FIG. 3) *) “Cracking” means here—since we use a shortened one-way hashing—not the restoration of the source value but the creation of a pseudo-source value which under the same hashing (same procedure, self-algorithm, key) leads to the same result (hash Value) and thus passes an exam positive.
   But even a single additional encryption offers especially in the long run no 100% security. As has been shown in past again and again, systems that are considered safe are often cracked after a short time. And this is not necessarily due to a key length that is too small.
   To further minimize this residual risk, follow the next steps.
3. The Masterkey used under 2. is arithmetically processed before it is used to encrypt passwords (hash value from 1.). (Pos. 5, FIG. 3)
   As an arithmetic calculation, for example, in a 128-bit key, a simple multiplication of the unique key by the second byte of the Masterkey multiplied by 12, a multiplication of the data field number by the seventh byte, an addition of the sixth byte by the column number, and an addition of the fifth word with a 16-bit checksum hash of the plaintext login name, and a bit shift of the fourth word by the one-digit checksum of the third and fourth character of the previous data field would be possible and the same with the second and column number-th character of the data field after next. But here many more combinations and methods can be used, and under circumstances also another encryption. The function/formula used should be as individual as possible to the application. That it is either created by the installer during installation (random) or specified by the manufacturer or user. An occasional (also randomly selectable) change of the formula parameters would be beneficial, but from today's point of view is not necessary and would also be a security risk if the parameters were not saved tamper-proof in the timer hardware extension for example.
   This ensures that each (database-) record is encrypted with a slightly different key (Masterkey), which almost eliminates pattern recognition (pattern recognition cryptanalysis) that can be used to calculate or hijack the key of captured data, and a possible attack on it is limited to the extremely time-consuming brute force (systematically trying all possible keys).
   Important:
   However, such a pattern recognition cryptanalysis would still be possible with the data fields which are encrypted with the unchanged Masterkey (if the subsequent stage can be broken). For this reason, a different Masterkey should be used for these data fields so that a pattern recognition attack that is successfully performed for these data fields does not catch on to the encryption of the other data fields.
4. In order to prevent any attacks according to the current state, the previously generated ciphertext (Masterkey encrypted (hash) values) is additionally encrypted with a Timekey that is only valid for 1 hour to 1 day, using a different encryption method as before with the Masterkey. (Pos. 6, FIG. 3) This will make an eventually looted Timekey worthless and any attack directly on the database server gets a temporary brisance which should make it even more impossible to succeed. In addition, a temporal relationship between key and data, which will be important i.a. in chapter L (claim 7) Thus, all passwords and other data are regularly decoded by a valid Timekey and encrypted with the the new Timekey′ immediately.
   An online attack is therefore impossible due to the short time frame and if the entire (encrypted) database is captured, their deciphering due to the three- to four-fold encryption depth is considered to be (timely) unrealistic, because the result of the first attempt at hacking (Timekey) does not provide a clear text that could show the attacker that he has reached his subgoal and there is—also due to the arithmetic processing and the different encryption methods—no single key with which the entire database can be decoded. The possibilities increase from 2̂128 (a 39-digit decimal number) to 2̂256, a number with 78 digits. If every calculation took only 1 pico-second (1 millionth of a microsecond), a computer would have been occupied for 3e57 years, whilst the universe only exists for 1.4e10 years.
   Now theoretically there is only the danger that the keys (Masterkey and Timekey) despite all usual precautionary measures (possibly together with the associated (multiple encrypted) data (-base)) are captured. That's why the next level of security follows.
   It should be noted that a 256-bit encryption is much easier to break than a double 128-bit encryption with different procedures and changing keys.
5. So far there are 2 keys (Original key) in the system. The Masterkey and the Timekey. To ensure that these keys can not be captured, they are generally not stored permanently, neither on disk nor in (main) memory. Instead, they are encrypted with a value, the time code, which is calculated from a future time value (time X) of the system (or a set timer value). Only the resulting Futurekeys are stored—hidden—and the originals (Masterkey and Timekey) are deleted immediately. (Pos. 7, FIG. 3 and Pos. 1-3, FIG. 1) But these Futurekeys are completely useless at the moment, because no key exists with which one them could be decrypted. They can only be reconvened to the original Timekey and Masterkey at a specific time, such is for example 0.5-2.5 seconds in the future, with the then given system time value (or timer alarm register value). (Pos. 4, FIG. 3 and pos. 6-7, FIG. 1) Only then can ciphering and deciphering tasks be performed again with these Original keys. In the meantime, pending decryption and ciphering requests are queued/buffered. They are then processed (at time X) by an interrupt program (timer program) which is called by a timer interrupt. The timer was set when the Futurekeys were created and must not be able to change or read after setting until it has expired or is triggered.
   At the end of the timer program, the Futurekeys are recreated, the timer is set, and the Timekey and Masterkey are deleted. (Pos. 3, FIG. 3)
   To generate a secure Futurekey, the respective key (Masterkey/Timekey) is encrypted with a minimum of 128-bit key (the time code) which is generated from an application-specific function with possibly changing/random parameters.
   The timer program runs completely exclusively in the system so that during which the Original keys (decrypted Futurekeys) are present, nobody can access it. Nevertheless, they are very well hidden, as well as the Futurekeys.

### J. ERROR CORRECTION WHEN STARTING THE TIMER PROGRAM

The calculation of the time code at the beginning of the timer program requires that the system time value requested by the system correspond exactly to the time X. And that to the smallest unit that is processed by the system time. So, for example 1 microsecond. But that is not always possible. On the one hand, it may take a few system clocks before the interrupt triggered by the timer, actually takes effect; on the other hand, a small amount of time passes by then due to the technical process. The first commands of the timer program also take time. Although this is likely to be in the range of two- to three-digit nanoseconds from today's perspective, even in this short time the system time can change to the next smallest unit. This must be compensated by an appropriate error correction. There are two options for this, depending on whether the timer hardware extension is being used or not.

1. without Timer Hardware Extension—Checksum Hash:

In this case, of each of the Original keys one e.g. 8 or 16 bit wide checksum hash (hidden) is stored. 16 bits should be the maximum size. It is small enough not to greatly simplify an attack on the keys, but is sufficient for the timer program to determine for sure whether the correct Original keys have been calculated. If not, it recalculates it again with a system time value reduced by a smallest unit of time. This is repeated if necessary until the Original key (s) could be calculated correctly.

Recommended size for the checksum hash is 8 bits. Ultimately, it depends on the performance of the system and must be adjusted accordingly. The faster the computer system used, the fewer bits in the checksum hash are necessary.

If more than 2 Original keys are encrypted to Futurekeys, it is still sufficient for a maximum of 2 a checksum hash to form, to test whether the correct Original keys were calculated.

In order for this checksum hash not to make it much easier for an attacker to recover the decrypted Original keys which, during their use, e.g. are hidden in the random matrix, it must be ensured that when creating the random matrix with random numbers, they are manipulated so that a certain proportion of the parts formable combinations of the same length as the hidden Original key, the same hash checksum must result like the real Original key. This percentage should be around 75-90% if one Original key is hidden in the matrix and proportionately if it is more than one. So 37.5-45% with 2 Original keys, 25-30% with 3 Original keys, etc. An example: A 128-bit Original key is to be hidden in 8 parts of 16 bits in the matrix. These 8 parts are stored somewhere in a matrix of, for example, 1 million 16-bit random values (see description Random matrix). Now, 75-90% of all possible 128-bit combinations of any 16-bit memory values of the matrix must yield the same checksum hash as the Original key hidden therein. If multiple Original keys are to be hidden in the matrix, this method need only be applied to Original keys that have a checksum hash stored. Proportionality remains the same (eg 25-30% for 3 keys). Without this method, an attacker would only need to try out all the comparatively fewer combinations that match the checksum hash and would thus save some/many time.

In itself, it would also be practical to form such a checksum hash for the time code, but the described method provides more security especially when using multiple Original keys. At most, a combination of an approximately 4-bit checksum hash for time code and an equally small for an Original key could be considered.

2. With Timer Hardware Extension—Read Alarm Register:

The timer of the hardware extension timer has some special features.

If it is a so-called countdown timer running from a set time back to 0, then the timer must continue to run after its trigger/release (to the minus) until it is read, so that the timer program can query and compensate the time delay by Reading out this overrun time.

However, if it is a timer in which any alarm time can be programmed then the value of the real time X is used anyway for this alarm time or the timer alarm time register—i.e. the value from which the time code can be calculated. Then this value remains until it has been read once in the alarm time register of the timer. Thus, the timer program only needs to read the alarm time register (which is not readable before the alarm time (trigger) is reached) and use this value as the basis for calculating the time code. An actual error correction is then not necessary. In this case, no checksum hash must be used too. This is the variant preferred by the inventor. Also note the extension as described in chapters O and O.1 (hardware random number generation) and the explanations in chapter D.

### K. PROCEDURE MECHANISMS AGAINST ATTACK SCENARIOS

1. Random Numbers

Random numbers are used at several points of the Method. The problem: a computer actually knows no coincidence. Random numbers are calculated from various parameters, whilst the system time usually plays the main character. Thus, a prediction or manipulation can never be completely ruled out.

Where random numbers are used for this Method, they should therefore, in principle, make use of multiple sources and form a combination thereof. In terms of software, e.g. the last movements of the mouse gladly included as the hand movement of a human is never 100-ig exactly or the same. In addition, it could be included an online related value. It is important to make sure that no matter which numbers are drawn here they can not cause any manipulation. Overflow, zero product, maximization, minimization, or division-by-zero must be excluded.

In any case, the random number generator used here must be a high-quality non-deterministic, cryptographically secure, random number generator which, moreover, can not be influenced from the outside. This can be realized in practice safely and effectively only with hardware support. There is special hardware for this purpose and the timer hardware extension mentioned several times is intended to also offer such a hardware-based random number generation. See chapter O.1 (hardware random number generation).

2. Low Timer Resolution and Key Width

If you do not use timer hardware extension and the system timer has only a resolution of 1 microsecond or higher, then this could initially be a risk for a brute force attack, given a 2 second time window for time X and 1 microsecond Resolution of the timer yielded only 2 million possibilities. That means the time code could be found relatively quickly by trying out 2 million different times. Assuming the attacker knows the application-specific function for calculating the time code.

a) Complex Calculation of the Time Code

To thwart this, the calculation of a time code using an application-specific function must be very complex, for example with complex numbers and high (for example, 2000-digit) powers, so the calculation takes a correspondingly long time (topic: radication, factorization, discrete logarithm, prime factorization).

A complete test for a hypothetical time X would involve the following steps:
time X→time code (for the regular system to do only once per timer phase)
Futurekeys→Original key (2 times)
Decipher some data to see if keys are working

The computational effort for such a complete run should take about 0.3 seconds, whilst about 99% of the time required to calculate the time code, otherwise the system would be useless. Assuming that a super-computer that might be used by the attacker to perform the calculations would be about 10,000 times faster, it would only take 0.03 milliseconds. (Note: The 10th fastest computer in the world is theoretically about 30,000 times faster than a top PC) So an attacker could have tried out in 1 minute all 2 million possibilities.

Since the time code is renewed every 3 seconds at the latest, this attack scenario does not pose any significant threat, but with luck, an attacker could eventually find the correct keys in those 3 seconds. If it is a pure offline attack, which means if you try to find the time code directly on the infected computer, this would be completely unpromising due to the lower computational power. However, this is the case only because of the complexity mentioned above. If that were not the case, then a compound attack (malicious program on server sends captured data and futurekeys online to a supercomputer in the top 50) could find the right keys in 0.05 microseconds.

It is also important to make sure that no conclusions can be drawn about the initial values due to the calculation time.

The mentioned above complexity in the calculation of the time code must therefore always be adapted to the current performance of commercially available top PCs or supercomputers. Nevertheless, this risk is not negligible, which is why for a real unbreakability subsequent solutions are necessary.

However, if the attacker captured some encrypted data for testing and all Futurekeys (that is, transferred to an external (super) computer) then there would be enough time to find the Original keys. For as long as the time code is valid. That should be an hour on average.

In addition, there is always the danger that an attacker succeeds in capturing the encrypted database including all Futurekeys and knows the function with which the time code is generated from the system time or time X.

This is one of the reasons why the following solutions and those in subsection 4 (technical progress) are decisive.

b) 128 Bit Freely Selectable Timer Register

As timer a certified hardware extension is used (claim 2), which could have a timer with a factor of 1.000.000 higher resolution. Thus, the time for an attack as described above ever increases to just under 2 years and the chance of a lucky hit is vanishingly small.

This timer hardware extension can provide additional services. These include e.a. stand-alone encryption, key management, random number generation and storaging all this. Above all, this timer can be set to any time as start time and alarm time, each with at least 128-bit registers. Thus, the time X, which is relatively still about 2 seconds in the future, but in the timer it is with a random value (as time) displaceable, thereby ensuring that the values to be tried by an attacker are much more than that about 2 seconds in the lowest time resolution. For example, a timer has 64 bits that usually stores a time stamp of date and time. By random number, this time is now set to any value. A kind of pseudo-time, which —unlike the standard system timer—can not be retrieved. Now the time X less the current time (that is, just the pure time span of, for example, 2.3 seconds) is added to this randomly selected timer time and programmed as an alarm time (which is also not readable by an attacker). This new alarm time is now a completely variable 64-bit basis for the time code which can be reconstructed later by the timer program because this only needs to read out the then existing timer alarm time to recalculate the time code. With 64 bit different possibilities, an attacker would have to invest about 2 million years. Well, you can assume that he does not have to try all the possibilities until the true Original keys are found, but if they were included in the first tenth, they would still be 200,000 years old.

However, considering that the performance of super-computers increases about thousandfold every 10 years, it becomes clear that it would not take too long to reach a serious risk potential, if not the mentioned above Complexity of the time code calculation is steadily adjusted. For this reason—as mentioned above—an at least 128-bit timer is recommended anyway (see subsection 4 “Technical progress” below). Given this, for time-saving reasons, the complexity of calculating time codes presented above can be omitted or reduced and the method is well on the safe side for 90 years. Each additional 64 bits brings another nearly 65 years of security.

3. Interface Communications

Every communication involves the risk of listening or being manipulated. For this reason, this risk must be eliminated for a consistently safe system.

Known is the communication between web server and web browser. Here, a good security standard was created with TLS/HTTPS, especially with its extensions (HSTS, random extension against DNS spoofing, station-to-station protocol, HTTP public key pinning). To extend it, the following procedure is applied to all communications in connection with the present method (between programs and between hardware), which also applies in particular to the communication with the task buffer of the timer program and which can be seen as an extension of the mentioned above Safety standards (TLS etc.):
Client sends communication request to server
Server sends a public key (OSI) for asymmetric encryption and Puplic-Key certificate to the client.
Client checks certificate at trusted certification authority.
Client sends own certificate if necessary.
Client generates an e.g. 128-bit random number as a symmetric key (SS) which he—encrypted with
   OS1—sends back to the server.
Server decrypts the SS with its private asymmetric key.
Server generates basic values ofa Diffie-Hellman-Merkle key exchange (DHM), prime number and generator, as well as its public DHM key (DHM1) and sends this—encrypted with SS—to the client.
Client decrypts DHM basic values and key DHM1 with SS
Client calculates its puplic DHM key (DHM2) with the received DHM basic values and sends this —again encrypted with OSI—to the server.
Server decrypts the DHM2 with its private asymmetric key.
BOTH have now exchanged their public DHM keys and can thus calculate the secret DHM key and start the actual communication. Thus, a new symmetric key can now also be exchanged or generated from the DHM key, which then encrypts the entire communication, since the DHM basic values were transmitted encrypted (differently), the security for the DHM was significantly increased (but not nearly as in chapter G.3).

This is an advanced version of the TLS protocol, which should normally be sufficient, however, according to current knowledge. In particular, the station-to-station protocol with additional digital signatures and message authentication codes should currently be sufficient.

However, the expected rapid progress of computing power could make the next stage meaningful. For TLS, asymmetric encryption and DHM are either or. Here it is an and. In addition, different encryption are used.

Decisive advantage here: Even if an attacker can record the entire communication and at some point has enough computing power available to break the asymmetric encryption, he just does not get the session key and can not decrypt the communication afterwards. Instead, he only gets the basic values and keys of the DHM protocol and would have to break this first, which may be considered safe with appropriate values of the basic values (>2000 bits). This circumstance makes the breaking of the asymmetrical key not insignificant more difficult.

Another advantage: The basic values (or at least one of them) of the DHM protocol could be assigned by the certificate office. So they are given to both communication partners without being part of the actual communication. This in turn means they are not to be captured by the attacker even if he has broken the symmetric encryption, or it would then first the encryption of the certificate to be broken. Since it is already known that when DHM's basic values (or a certain subset) become known and key sizes are below 512 bits, DHM is quite likely to break in a short time, this method should never be used in such a way that these basic values can be overheard. That means these basic values must not be transmitted unencrypted. The recommendations of the BSI on the length of these basic values must be taken into account. Similarly, the DHM process should be renewed within a short space of time, within the existing one, so there is a need for a steady refraction.

So that the secure data protection method of the present invention is not otherwise been weaken, the currently most secure communication protocols and methods should always be used for communication. When passwords are transmitted, this procedure is further expanded. See G.3.

For the transmissions to the task buffer, long-term asymmetric encryption should suffice due to the short lifespan of the buffer. That means the timer program creates a private key for each pass which is encrypted until it is used with an altered Masterkey and Timekey and a public key is created which is given to all communication partners. Since there may be overlaps, the last private key is also saved. A short (8 or 16 bit) check digit on each buffer entry helps to ensure that the correct private key is being used.

The timer program will also use various algorithms to detect if the entries in the task buffer may have come from an attacker and respond accordingly. Since credentials are generally never deciphered, an attacker could gain up to a mostly 4-times encrypted datas, which would be enough to need the lifespan of the universe to decipher, only after a further 300 years of technical progress.

4. Technical Progress

Today, the first supercomputers are already scratching the 100 PetaFlops mark. At some point—even if it seems impossible today—even such elaborate multiple interleaved encryption, as presented by the present invention can be cracked. Someone who gets the complete database and the Futurekeys through a very clever attack, might crack it in X years.

For example, the 10th fastest computer (10 petaflops) is used to crack a 64-bit key. It does not use an algorithm but simply tries all possibilities, with 50 flops per pass. He would be through in a maximum of 25 hours. And,—the right key is—statistically speaking—most likely not quite at the very end of the test series.

This makes it clear that 64 bits today no longer represent any appreciable security.

a) 128-Bit Timer Register

From this point of view, it is crucial that the time code contains at least 128 bits of different possibilities. That means its values must be based on a 128-bit timer. In other words, anyone who wants to break the time code must test at least 2̂128 options. The application-specific function additionally increases the security to e.g. 192 bits, but if an attacker has become aware of this feature, then we definitely talk about 2̂128 possibilities.

An example: an attacker loots the entire database along with the Futurekeys and timecode function. Breaking down the overall encryption of the database is still unrealistic in hundreds of years. Therefore, one would concentrate on the refraction of the time code (which of course only makes sense if the futureskeys has been captured as well). The function is present (was also stolen), which is why the attackers would need a maximum of 2̂128 runs. The solution is not only at the end but assumed unfavorable in the first 1000th part. This leaves 2̂118 runs, with one run requiring 50 flops (no complication). It would take 52 trillion years.

However, in 30 years SuperComputer could realistically be 1e9 times faster and then it would be “only” 52.687 years. But what happens if quantum computers can actually be used in 20 years? In a not completely unrealistic further progress leap of 1e6 the key is cracked in 19 days.

This makes clear why a bit width of 128 should be considered as minimum in all key-relevant areas and the time code is recommended to be at least 192 bits. Furthermore, with data that should be safe even in 30 or 50 years, a 192 or 256 bit timer would be highly recommended. 64 additional bits provide an improvement by a factor of 18 trillion. That will be enough for another 60 to 70 years. A complicationing of the time code function can make sense up to a factor of 1000 and offers in any case a little more security (about 10 years).

The variant, randomly from a 128-bit timer to get out real 2̂192 necessary passes is in chapter O.1. (Hardware random number generation) described.

It is even better, however, if it is simply not possible—as explained below—to capture the Futurekeys completely.

b) Encrypt Futurekeys and Hide them Splitted

For this purpose, the futurekey of the Masterkey (MK-Futurekey) is hidden in one or more sufficiently large storage media, except the main memory of the system, and so that it is impossible to obtain a valid complete futurekey by browsing or downloading and subsequent browsing. It must not be possible to completely capture the storage medium/storage space used in less than e.g. 10 times the time in which the hidden key, or the Timekey with which it was possibly encrypted, has the longest validity. This must be ensured on the hardware side by the correct ratio of read speed of the storage medium, its size and the maximum time span until the (almost) regular renewal of the hidden key or Timekey and a distribution of the key to be hidden in parts on the entire storage medium.

This important feature of this method complies with claim 7 . . . .

### L. DESCRIPTION CLAIM 7: (HDD-MATRIX—HIDING PLACE FUTUREKEYS)

Method according to one of the preceding claims, wherein

data, but in particular cryptographic keys with a, to be renewed at certain intervals, key, here referred to as Timekey, encrypted and then split in several parts on a randomly filled, stored storage medium, wherein the maximum time interval for renewal of the Timekey and the associated new encryptions, the size of the storage medium and its reading speed are in such a relationship that the following applies: size in MByte>=read speed in MByte/sec.*Multiple*maximum time interval for renewal/re-encryption of the key in seconds.

The specific time intervals are explained in detail in the scope of claim 4 on the subject of Timekey. In essence, the magnitude may vary between 1 hour and 1 day, depending on the performance of the system, with the ultimate size determined to have some variability in practice in order to be unpredictable.

With key (Timekey) here are meant not only Timekeys in the sense of claim 4 but also all other keys and in particular also Futurekeys whose validity is on average only a few seconds.

1. Regular Distribution

A storage medium is described in advance completely randomly. The magnitude of the random numbers must be the same as part of the split (encrypted) (Masterkey-Futurekey) key to be hidden. That would be e.g. splitting a 128-bit key into 8 pieces, a 16-bit value. It must be possible to be able to access individual areas/cells of the storage medium directly in order then to be able to “plant” (write) the parts of the split-up (encrypted) key there directly. Just as one can directly access any memory cell in the case of main memory.

The locations of parts of the splitted key should be completely random but well distributed. Thus, there must be a high probability that a part of Y (1/Y of the key) is also approximately in 1/Y of the storage medium, allowing for overlaps on up to 1.8/y of the storage medium. Assuming that the storage medium is 1000 MB in size and the key is split into 8 parts, it could look like this: Assuming that the storage medium has already been formatted into 16-bit cells and filled with random numbers, it is thought to be divided into 8 areas. At the beginning and at the end a small variable buffer of 12 MB each is installed. Each eighth of the key should therefore fit in a sector of size 122 MB, with an occasional exceeding of the sector limits up to 180%. Of course, the limits of the storage medium must be taken into account and there are no key parts on top of each other or next to each other. Accordingly, the first sector starts at 12, the second at 12+122=134, and so on. Each of these sectors will now house of one-eighth of the key, with an occasional overlap. Also, the order of the parts on the storage medium should not match the actual one. The formula for determining the storage locations could look like this:

Cell=average of 2 random numbers from 2.6 minus 0.8 plus start number*122+12, minimum 0, maximum 1000; each multiplied by 500,000 then gives the 16-bit address

It would also be a random location determination over the entire disk conceivable. But then it would have to be ensured that an unregular distribution does not take place.

2. Especially Slow Storage Medium

A “multiple” determines how much of the entire storage medium can be read or downloaded within a maximum period of valid time for the hidden key. The minimum is 3. Will be multiplied by e.g. the recommended value 10 can be used—no matter who and from where—only 1/10 of the storage medium could be read until the hidden key is renewed again. Thus, you never have the chance to get more than 1/10 of a correct key. While the attacker continues to read, the other 9/10 are already provided with parts of newly encrypted keys and the old ones are safely deleted. In the end, the intruder would only have 10 snippets of differently encrypted keys.

So that no parts of old (encrypted) Futurekeys are to be found in a possibly captured storage medium, these are, as soon as they are no longer needed safely deleted and filled with random values.

For example, assuming a time rhythm for the renewal of the Timekey of one hour and a best (worst case in that relation) average read/download rate of 100 Mbit/sec., so the volume in which the MK-Futurekey encrypted with the Timekey is to be hidden has to be at least 450 GB in size.

Size in MB>=Speed in MByte/sec.*(10*Timekey-renewel-time in seconds)

Speed in MByte/sec.<=Size in MB/(10*Timekey-renewel-time in seconds)

By “Speed” is meant the reading or transmission speed of the storage medium and under “Timekey-renewel-time” is the maximum time until the hidden key is renewed again and again to understand.

Actually, efforts are being made to constantly expand the reading speed of storage media. For this area of this privacy policy, the reading speed is deliberately limited. This must be fixed on the hardware side and immutable. The limit should be such that it does not cause a noticeable delay in the processing of the ciphering work (of the timer program). If the storage medium is large enough and the time to renew the hidden key very short then under circumstances (no cache, for example) could be dispensed with a limitation of the reading speed.

A Futurekey is basically only valid for about 3 seconds until it is removed, decrypted, used and encrypted again (differently). Assuming a reading speed of 1 GB/sec., from what is currently a good speed of a modem SSD, the memory would need to be just 30 GB in size.

Basically, you can set this about 3 seconds until the renewal of the Futurekeys as a time span and is sufficiently protected. The effort is low. Further encryption of the Futurekeys with e.g. the Timekey is not necessary per se. However, it must also be ensured that even during a system restart there is no time span in which a valid key spends more than 6 seconds in memory. Otherwise, it is necessary to switch to the longer period of time.

Although you could even invoke the even slower download rate, but an attacker could then first copy the matrix memory area to another area 1 volume and then download it in peace.

It must also be ensured that the matrix memory area can not be blocked in any way, since this the attacker could prevent the system to renew for example. ⅞ of the key in the matrix memory before it could be captured.

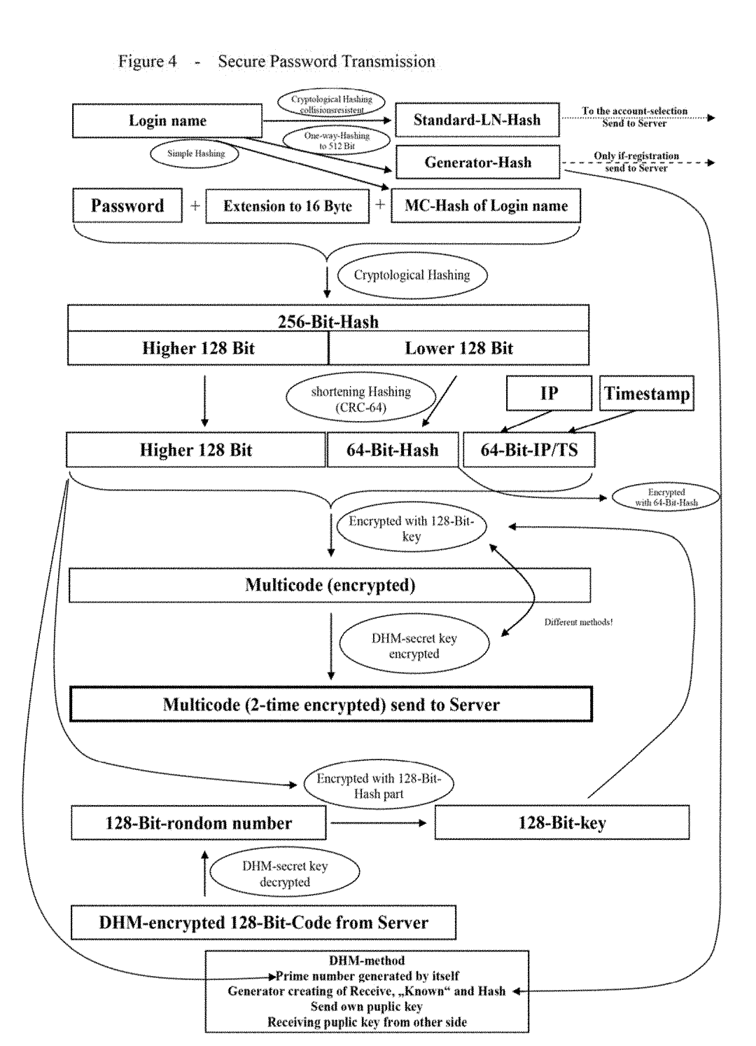

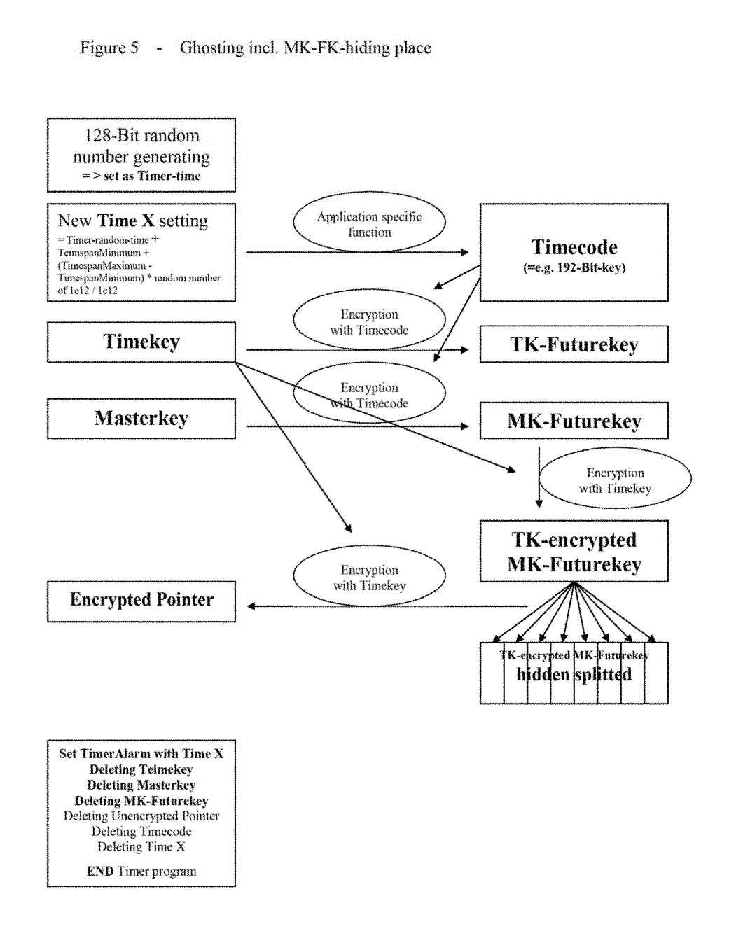

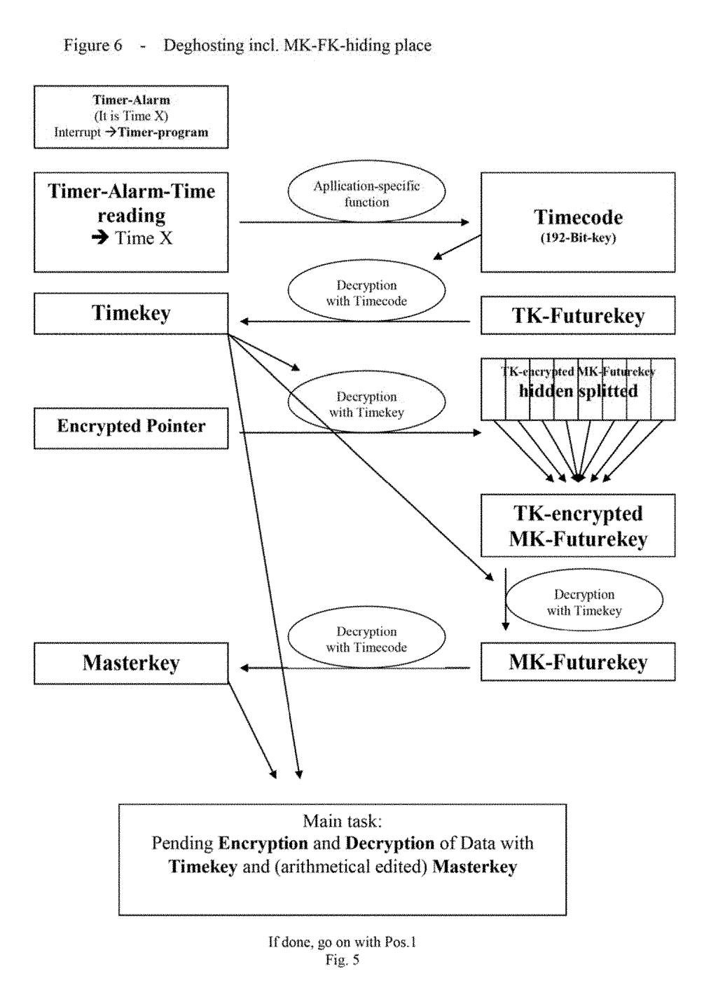

The Masterkey futurekey is thus (possibly encrypted with the Timekey) fairly evenly split in a matrix of equally large randomly selected key parts hidden on a storage medium outside of the main memory. Where, is randomly determined and noted in pointer which are (also) encrypted with the Timekey. This is done by the timer program and thus about every 3 seconds. See FIGS. 5 and 6.

The pointer are sufficiently protected with the Timekey encryption for this short time, but could still be hidden. See below the explanation for hiding pointers to the Timekey futurekey.

A further increase in security can be achieved by distributing the hiding place for the Masterkey Futurekey randomly on several, ideally type-different, devices, so that it is never certain on which device (s) the Futurekey is hidden. Which means different storage media of the system (not the main memory in which also the Timekey Futurekey is stored) but also memory of other systems which are connected via networked or secure (cloud) servers on the Internet, provided they guarantee the read speed limit above in relation to their size and the renewal time of the Timekey or Futurekey. A protected memory area on the timer hardware extension is also an option. However, this step would only be necessary if there is a risk of physical misappropriation of the individual storage medium, whereas the timer hardware extension can be protected for. However, the timer hardware extension would also have the advantage that it generally does not permit read accesses during the time when the timer program is not active.

The clear disadvantage of a network storage medium is that the network traffic could possibly be tapped, making the entire hiding place meaningless.

It does not matter if the hard disk itself is so slow or the connection there, but the former is clearly to be preferred as it makes network or connection manipulations pointless. For example, if a 1 TB storage device has only 10 Mbps. transmission speed available, then for the retrieval of the key by the timer program, which knows exactly where he is, does not matter much. It takes then just 13 microseconds instead of 1.3 microseconds, which extends a 3 second run only insignificantly. However, a download of this 1 TB hard drive would take 9 days.

If you have captured everything except the Masterkey, it means that it makes more sense for an attack to break the two Original keys Masterkey and Timekey (together 256 bits) instead of time code and then Masterkey (320 bits together). Even in 150 years, when supercomputers have the unimaginable 1e45-times performance of today, it will still be impossible to break such a protected database, as 2̂256 possibilities would have to be calculated. That still requires 18 billion years. But then you should slowly switch to 512 bit at the latest. That will be enough for another 250 years. Of course, no one can tell if the progress of computational speed continues so rapidly. There are physical limits somewhere. But it could even go even faster if larger quantum leaps are achieved.

When saving to hard disk (s), ideally the so-called direct access is used to dump the futurekey somewhere without the file system notifying it. In general, the storage process must be set up so that no traces are left or such must be deleted separately. A caching should be deactivated and generally not be activateable. For example, SSDs are unsuitable due to the special internal memory management, unless you can use a modified firmware to achieve a counterpart to the disk's direct access.

So that the data protection system can find the MK Futurekey again, the exact place of the hiding place or the hiding places is secured in pointer which are encrypted with the Timekey. The seizure of these would be irrelevant as long as the Timekey could not be cracked within its validity or even the validity of the Futurekeys. If, for performance reasons, the Timekey is only renewed daily, the pointer can be additionally encrypted with the time code, which changes every 3 seconds.

3. Time Brisance

So the MK-Futurekey is to be found only after successfully cracked Timekey (Futurekey) but until then he is long since somewhere else, because its whereabouts changes approximately every 3 seconds and also it is no longer valid. The complete stealing of all possible locations of the MK Futurekey is eliminated due to the enormous size and variety of these possible hiding places—especially within the validity of the Timekey or even the Futurekey (time X, for example 3 sec.). After the currently upcoming time X both Original keys are already encrypted again with a new time code to new Futurekeys. Due to the size of the possible locations, it is not possible to capture both Futurekeys so that both were generated with the same key (time code). Thus, it would not be enough just to crack the time code. This would only lead to one of the two Original keys, the Timekey, but now the time code would still have to be found with which the younger or later received Masterkey Futurekey was generated. Even if you could make a memory dump every 0.5 seconds while downloading all potential memory locations, due to the long download time for each time X you would only ever have a small part of the valid Masterkey Futurekey which is completely useless.

4. Independence of Computing Speed and Technical Progress

Only if the Timekey can be found within its validity, what means the time code is cracked, whereby the Timekey can be deciphered from the Timekey Futurekey, the Masterkey futurkey parts could be found (and specifically looted) by decrypting the pointer to the hiding places. But since the time code changes every 3 seconds and so also the Futurekeys and their whereabouts, everything would have to be done in less than 3 seconds. But until a supercomputer can play through 2̂192 options in 3 seconds, just under 134 years have to elapse, but the problem is that the attacker first knows if he has the right Timekey, if he then looses the Masterkey and then with both to test some data for plain text. This in turn means it can not be tested on an external system alone, there must be a download of the potential parts of the Masterkey Futurekey from its (especially slow) hiding storage media for each test, which is why this time and not the progress of computing speed forever will be the bottleneck. And if every access to a potential Masterkey Futurekey takes, for example, 13 microseconds, then we are talking about 2.6e42 years to try out 2̂192 possibilities. And that will always be the case, no matter how fast the computers of this world are becoming.

This means that limiting the access time of an externally (not in main memory) hidden Futurekey completely eliminates any computing power and not only ensures the impossibility of a complete theft to then look for the key in peace, but also thwart any brute force attack forever.

Incidentally, finding a key split into 8 (2-byte) parts from a 450 GB storage medium means 225e9! : (225e9-8!): (8!)=1.6e86 options, roughly equivalent to 286-bit encryption. Well, —the sectoring (even distribution) reduces the possibilities, but then the correct order must be found and we are back at 1.5e88. With a doubling of the split parts could also be doubled the number of possibilities, but this can be considered unnecessary due to the impossibility of reading in necessary time.

Ideally, the Futurekey of the Timekey is also hidden in such a, but possibly different, storage medium in the same way as the Masterkey Futurekey.

Incidentally, this part of the process even provides effective protection against a processor dump if it can not be safely permanently deactivated. Although the pointer could be captured with the dump and possibly even found and decrypted (=time code break), but until then the key to which he points, is no longer there long ago and the storage medium in which the key would have been found, could not be captured because it was not completely readable at the time the key was there.

You could hide the (encrypted) pointers to the hidden Futurekeys as well, but it only brings a marginal security gain overall.

This important part of the overall Method forces the attacker to crack the time code and thus the Timekey within about 3 seconds, which is impossible even without timer hardware extension and provides an unbreakable Method altogether, even without timer hardware extension, assuming the existing timer can not be read out. Because the solution shown in Chapter K.2.a) (Complex Calculation of Time Code) has the disadvantage that it depends on the computing power. This is not the case with the read delay shown here. This is still true in 1000 years and this is regardless of whether the attacker has a super computer or not. So if you apply the read delay of 0.3 seconds shown in K.2.a), even with a low-end countdown timer, the number of (only 2 million) options would be sufficient to let become an attack to a pure gambling. But, statistically speaking, after one day and 30,000 attempts, one try could have this luck, which is why it should be at least a timer with a much higher resolution than 1 microsecond or equal to a 32-bit alarm timer. However, these could be unlikely to be unreadable or configured like that.

Ergo: Either countdown timer with resolution of 1 nanosecond or less, or better the timer hardware extension.

### M. DESCRIPTION CLAIM 8: (READ-ONLY MEMORY—HARDWARE EXTENSION)

Method according to one of the preceding claims, wherein

Programs and data which serve the data security of the data protected by the aforementioned claims, such as i.a. Software for enciphering and deciphering and the timer program mentioned in claim 1, on a non-volatile memory chip which can only be changed/written by means of manual hardware intervention, such as e.g. an EEPROM on the mentioned above Timer hardware extension, are housed and either this memory chip directly fades in l/overlay a specific memory area of the main memory of the IT system, which performs the tasks of the preceding claims, or the mentioned above safety-relevant programs and data are loaded from it and regularly compared with it.

Programs in the main memory (RAM) or on hard disks/SSDs can be manipulated. This may result in their disclosure of the specially protected data or keys. For this reason, such manipulations must be prevented. The safest variant is a so-called solid state memory chip, such as a ROM (read-only memory). However, this has the disadvantage that it is not updateable. Therefore today the basic start-up software of computer systems such as e.g. the bios stored on flash memory. The disadvantage: they can be reprogrammed purely by software. However, this is unacceptable to the present invention and the requirement of uncrackability. For this reason, it must have a non-volatile memory (this means, it does not lose its memory content even with the device off/de-energized), to be writeable only by a manually operated button or jumper. This ensures that no unnoticed malware can be able to change the memory contents. Nevertheless, there is the possibility to import updates provided that an authorized person on site operates the necessary switch. Incidentally, this should optimally be secured with at least one key and/or code lock. Other security measures such as biometric scanners can increase security at this point.

An Eeprom is a permanent memory that can be erased and rewritten via a separate voltage. An Eprom is erased by UV radiation and can then be rewritten. Of course, any other non-volatile memory is conceivable if its writing is blocked on the hardware side or only by manual hardware intervention is possible. It would also be conceivable that the chips are ROM modules on a socket and the software supplier delivers the updates in the form of new ROM chips. If the authenticity is ensured this would be the safest variant.

It must be ensured that the writability is automatically deactivated again after the update has been performed, or at least after a certain time (for example 15 minutes), if the resetting of the write mode by the user is forgotten.

To prevent tampering (for example, with a rootkit/bootkit) during this write process, the update of such a memory device could be executed on another system, which by default is never connected to the network. Of course, as an update program only one of the manufacturer of the data protect software can be used which compares the integrity of the update several times.

The delivery of updates, no matter in what form, must follow strict security criteria, so that manipulation in this way can be excluded. The recipient must always inquire with the manufacturer and authenticity must be proven by means of certificates. Multiple checksums ensure the authenticity of the software.

Ideally, this memory fades into/overlay a specific memory area of the system's memory (similar to the ROM/Flash for bios). This may require a small change on the motherboard of the computer. It would also be conceivable to have an adapter which operates between the board and the RAM and thus redirects read requests to a specific memory area on the e.g. Eeprom.

Otherwise the software will be loaded directly from the e.g. Eeprom and by various programs such as the database application, a separate comparison program, the timer program, special system drivers, etc. regularly compared whether the programs in main memory still match those in the read-only memory, so that manipulations of the program code are quickly detected.

### N. DESCRIPTION CLAIM 9: (INTERRUPT-POINTER—HARDWARE-EXTENSION)

Method according to one of the preceding claims, wherein

the mentioned above Timer hardware extension according to claim 2 or another hardware device checks whether the for calling the tinier program responsible interrupt pointer according to claim 1, was manipulated, which by the hardware shortly after the triggering of the timer independently check, whether the for the execution of the timer program responsible processor actually operates in the memory area in which the timer program is stored and otherwise triggers system alarms and/or stops the IT system containing the data to be protected;

wherein interrupt pointer means the start address of the timer program in the working memory of the executive IT system, which is entered as soon as the timer of claim 1 triggers.

Another danger of manipulation lies in an unauthorized change of the interrupt pointer, which points to the timer program (see step c, claim 1, or chapter C.5). This could be bent over to a malicious program, which then takes over the deciphering of the Futurekeys with the thoroughly experienced procedures and parameters and the automatically correct system time, and steals the Original keys, or decrypts data and passes it on illegally. For this reason, it is crucial that this interrupt pointer is protected from those changes or changes are at least detected immediately.

This could be done by the already mentioned timer hardware extension (if it is used). As described in claim 9, the hardware checks whether, after the timer interrupt, i.e. after triggering of the timer, the processor or one of the processors, actually works in the memory area in which the timer program is stored. The processor must repeatedly access this memory area. This will certainly happens batch-wise due to today's usual memory burst technology and larger processor caches, but some operations can only occur when the processor accesses the addresses of that memory area. This can detect a hardware by “reading” the address applied to the address bus even if it is not selected (see FIG. 7, address-to-data converter). This must then be evaluated. A program leaves a certain “signature”, which is to be checked by the hardware. If, for example, depending on the system, 100 processor clock cycles after the interrupt, this program signature have not yet recognized, a manipulation can be assumed. The hardware reacts then with most different measures, whereby parallel to an alarm probably a system stop should be the most meaningful, so that a possible damage is immediately averted or at least limited. The system should then be disconnected from the network and by security professionals a controlled start up or reboot must be initiated.

Another alternative would be the inspection of the so-called processor stack.

These checks can be omitted if—which would be optimal—the responsible interrupt (NMI) pointer is fixed on the hardware side so that manipulation without manual hardware intervention are excluded and this interrupt (NMI) pointer points to the timer program—best placed on a ROM,

If you are not working with the timer hardware extension, this check must be done otherwise. See chapter R.2 “Software Integrity Check Mechanism”.

### O. FURTHER SERVICES/FEATURES/DETAILS ON TIMER HARDWARE EXTENSION

In order to ensure the previously described functionalities of the timer (for example unreadability until triggering, etc.), this must most likely be made available to the system as a special timer on a separate hardware, the timer hardware extension. See claim 2, chapter D.

In order to ensure the full functionality of the timer hardware extension shown in this method, in particular also the claims from claim 8 and claim 9 as well as the following services, the timer hardware extension itself can be constructed like a small computer and can execute independent programs. Of course, the timer hardware extension will not have interfaces that pose a security risk. The timer hardware extension will have a timer, a random number generator, a read-only memory (ROM), an external read-only memory (Eeprom), and a RAM/flash memory. See FIG. 7.

It should be completely shielded, which also serves as a security housing which could trigger a kind of self-destruction when opening.

For explanation of FIG. 7:

The illustration (FIG. 7) is not complete but only a rough schematic overview, which is intended to represent some essential modules and connections. The lines from the address logic to the respective modules include, for example, at least 2 lines. Either Select and Read/Write or a Read and a Write line. The Sel.-Logic ensures that the timer is only accessible after it has triggered, with which the alarm signal is high. But only once. In fact, the alarm line additionally sets an internal AND flip-flop, which, however, is reset by the falling flank of the read-select signal. Thus, reading is only possible again after the next alarm.

These are all just exemplary embodiments. There are many design options to realize the repeatedly described and subsequent performance requirements of the timer hardware extension.

In addition to the functions already described, in particular from claims 2, 8 and 9, the timer hardware extension is intended to provide the following functions/services/features:

1. Hardware Random Number Generation

The problem with the generation of true random numbers has already been described in detail in point K.1 (random numbers) and it has also been stated that the timer hardware extension must therefore contain a hardware-based non-deterministic random number generator of highest quality in order to maximize the security of this Method.

a) Non-Deterministic Random Number Generator

The random number generator of the timer hardware extension could operate on the principle of thermal noises of resistors in combination with voltage fluctuations in Z-diodes. This in combination with the smallest unit of time (picoseconds or less) of a counter gives a safe random number, especially if the clock generator of the counter does not have such a high quality and thus higher fluctuations.

For reasons of influenceability, generators are excluded which derive their values from the noise of certain radio frequencies or the electric power grid. Also, the influence of temperature must not lead to predictable or repeatable results.

Of course, for security purposes, this hardware random number can be combined with software random values, provided that the requirements of Chapter K. I (Random Numbers), in particular tamper-evidence security, are met.

b) Parameter Generation

Random numbers are mostly needed to generate cryptological keys (Original keys), such as the Timekey. The present method ensures that these keys are protected against unauthorized access. However, this must also be ensured when it comes to parameters.

These are numbers as parts of a function or formula which e.g. the calculation of the change of Masterkeys takes over. If an attacker could manipulate these parameters, the entire system could be compromised. Therefore parameters may only be used as far as any manipulation is excluded. Thus, changing parameters should be stored on the timer hardware extension. See the explanations under the following chapter numbers 7.b) ft.

c) Automatic 192-Bit Time Code and Time X.

A special feature is the generation of the time X and the time code by the timer hardware extension. The timer hardware extension, in addition to time X, which is a 128-bit value for the free alarm time register as well as on the timer hardware extension, could generate a (64-bit) random number which is not experienced outside the timer hardware extension (see 7.b)) multiplied by the time X (128-bit alarm time) or simply appended left as an additional 64-bit, giving a 192-bit value; The time code. This is communicated to the timer program immediately after the timer has been set (so that it can encrypt the Futurekeys with it) and shortly after the timer interrupt via the timers and alarm time registers of the timer, which are only to be read once. This gives the time code a real 2̂192 possibilities instead of the 2̂128 that it otherwise has and of course can be extended even further to 256 bits and more with appropriate adaptation.

A flow example: A 64-bit and a 128-bit random number are generated. The 64-bit number is written to the time register and the 128-bit number to the alarm time register. The timer hardware extension now waits until the registers have been read out once, which recognizes them by an And logic of read and select signal of the timer. This read sets the select logic to inactive so that further reads do not work. Now the time register is set to the value of the alarm time register minus the desired time X and the timer is started. From now on, reading is blocked anyway until the timer triggers, i.e. the value in the time register reaches the value in the alarm time register and the alarm signal becomes “high”. The latter triggers the system NMI interrupt, which calls the timer program, enables the select logic so that the timer can be read once again, and the time register is set to the internally cached 64-bit value.

The timer program reads this value and the value of the alarm time register and has a real 192-bit time code with which it can decrypt the Futurekeys again without the need for a parameterized function for extrapolating the time X to the time code.

2. Software Integrity Audit Mechanism

If, due to the system, the direct (fade-in/overlay) execution on e.g. Eeprom located program codes (for the timer program, etc.) is not possible, the microcontroller on the timer hardware extension independently and regularly, in very short intervals, but not predictable, checks the integrity of all security-related programs, in particular the timer program.

This is done partly with checksums but also by direct comparison of the memory contents of the working memory in the address range of the timer program with the timer program on the Eeprom or possibly a copy thereof in the ROM or internal RAM of the timer hardware extension. Access to PC memory should be via DMA (Direct Memory Access) or similar.

In practice, a combination of occasional full comparison and much more frequent checksum checks should be the best compromise between performance and monitoring.

Thus, for this embodiment variant, the risk of manipulation is minimized and ensured that manipulations are detected before they can cause significant damage. The timer hardware extension responds as usual to such a hazard with alarm sound, system alarm and system stop.

3. Ciphering and Deciphering Functions

The timer hardware extension should provide at least 2 symmetric encryption and decryption services and possibly an asymmetric one with one permanent and unchangeable key and the other one with, by initialization (by the timer program) from outside, with on the hardware extension generated random numbers keys operates. Both keys should be at least 128-bit keys AND be unknown and unreadable outside the hardware device.

These keys are intended to further encrypt the Futurekeys and pointers to their hiding places, but they could be used elsewhere. In the event that they are also used to encrypt data, there must be additional keys on the timer hardware extension, as they would then have to be backed up outside the timer hardware extension and this is not allowed for the first two keys.

The decryption/ciphering services (also for the following features) can be realized via the internal microcontroller, possibly in cooperation with a floating point unit (FPU) as shown in FIG. 7, and/or via special crypto chips.

4. Automation System

The more of the entire privacy procedure is processed on the timer hardware extension, the better. In this respect, the following variants are to be seen as additional security enhancements:

a) Timer Programs Itself

The timer program transfers to its end the pointer to the Original keys in the matrix, as well as the limits for a new time X to the timer hardware extension. This generates with its own random number generator a new time X and a time code and sets independently their timer. The generated time code can be provided to the timer program for single reading via the time registers.

b) Self-Encryption to Futurekeys

The timer hardware extension extracts the Original keys from the matrix, encrypts them with the time code and writes them back or makes them available to the timer program at a specific address of the externally accessible memory or stores the generated Futurekeys in the internal key memory which can not be accessed from the outside and which may also be part of a large and slow matrix.

c) Self-Decrypting the Futurekeys

As soon as the timer is triggered, the timer program is started by interrupt which prepares the matrix in the working memory. When this is done, the timer program will give a “signal” including new matrix pointers for the Original keys to the timer hardware extension. Now, the timer hardware extension decrypts the internal futurekeys with the time code (e.g., alarm register value of the timer) and places them in the matrix.

d) Hardware Extension Undertake Ciphering

A further increase in automation is when the timer hardware extension does not give out the Original keys at all, but instead performs the decryption and ciphering tasks itself. In order to make sure that the requirements really come from the timer program, they will be encrypted or edited and transmitted back and forth with the last (current) alarm time. However, the parameters for the respective arithmetic editing of the Masterkey would have to be transferred as well.

However, the Original keys are allowed to be stored only in the internal memory of the microcontroller of the timer hardware extension, so that a theft of this is technically impossible. A corresponding check of the card would also need to determine if an attempt is made to remove the timer hardware extension while maintaining the power supply. However, if this can be done, the entire computer could possibly be stolen, but this would be detected by the optional GPS module of the timer hardware extension. Furthermore, the timer hardware extension would of course reject any decryption requests outside of the timer sleep phase (timer program (exclusive) active) and the data to be encrypted/decrypted would have to be transmitted at least arithmetically changed with the last alarm time register value and the result is returned arithmetically changed in an other way to prevent misuse of the decryption/encryption service of the timer hardware extension.

Advantages:

The main advantage of course is that the Original key and possibly Futurekey by hardware design can not be stolen. These are only given out or printed out scrambled once when generated new Original keys. For backup purposes.

With appropriate design also a performance profit should rise up.

Disadvantage:

It only works with a maximum equipped timer hardware extension including microcontroller.

If someone has the impression that this would be almost like a TPM (Trusted Platform Module),—is wrong. A TPM has a completely different purpose. It is not part of a Method and thus does not work with an interrupt program. The Masterkey is also generally not given out. Not even for backup purposes. A TPM is based on asymmetric encryption, offers no program memory and no intelligent memory management and above all no intelligent access control. That means a TPM is relatively easy to abuse. Compared to TPM and other concepts in the classic Minni computer concept is essential:
Programs are not executed by RAM but exclusively by ROM. Manipulation or intrusion of malware is excluded.
External access is very limited in terms of hardware.
The communication takes place via an encryption/arithmetic processing with the timer alarm time as constantly changing, completely secret key.
Address-to-data converter
Masterkey encryption with arithmetic change
Integrated Timekey concept

It would also be conceivable to integrate an SSD with the timer hardware extension. On such a SSD with e.g. 1 TB of memory could be stored over one billion primes, each with about 1000 decimal places. These could be constantly updated by the timer hardware extension during idle times. (On topic G.3)

The automation could indeed be driven so far that it no longer needs a timer program, and its functions are completely executed by the timer hardware extension itself.

It would have then just there various algorithms to be integrated to detect statistically unusual requirements, or deciphering be requested to data from users to whom there is no login or no IP connection, etc.

5. Address Control

To prevent tampering, the timer hardware extension checks to see if the write and read commands are sent to it for e.g. the timer or for memory of the timer hardware extension or for requirements of encryption or decryption services actually made from the address range of the timer program. This is achieved by the microcontroller on the timer hardware extension constantly “listening” to the address bus and writes the last for example 100 addresses in a roulizing memory. If a write command now arrives at the timer hardware extension, it can use the last addresses to determine from which memory address this write command was initiated and compare this with the memory area of the timer program. If this is not the case, the hardware triggers a system alarm or if necessary stops the system to avoid any further activity of the obviously existing malware.

Although the current burst technique makes assigning current read/write access significantly more difficult, but it is still possible with a possibly longer address data buffer.

In FIG. 7, this feature is shown with the module “address data converter”. It provides the value of the address bus to the data bus and/or stores, for example, the values of the last 100 clocks.

In addition, it is always possible to trigger an NMI/interrupt. The interrupt program can then analyze the processor stack to determine which program was executed before the interrupt.

Generally, write commands to the timer hardware extension are made as directly as possible from the timer program and without intervening drivers or that like. If this is not possible due to the system, the integrity of the respective driver must be additionally ensured.

6. Theft Protection

An unusual but not totally unthinkable attack scenario would be the physical theft of the timer hardware extension, if used to store keys (as discussed in the previous chapter Automation). If this happens in the usual way, the data would be protected because they are lost in the event of a power failure, provided that no non-volatile memory is used. In addition, the timer hardware extension microcontroller program will have techniques to detect theft even if essential signals and power supply are ensured during this process. These techniques must go beyond duplicable hardware IDs and signatures, and could possibly include a GPS/Gallileo module as well as sensitive gyro position and acceleration sensors. The topic of shielding is taken up under Q.7. In any case, such could also be used to prevent access to the hardware of the timer hardware extension and even accommodate some sort of self-destruction.

7. Flash/RAM Memory

The timer hardware extension has a read/write memory. (FIG. 7, RAM)

Depending on requirements, this may be flash memory (or equivalent), which retains its data even when power is lost, or a RAM (or equivalent) that loses its data in the event of power loss, which can be an important security feature for certain scenarios.

In FIG. 7, this memory is represented by RAM, which, however, is not intended to be a definition of this type of memory.

For explanation of FIG. 7:

The address logic 1 ensures that only a small part of the RAM (or other read/write memory) is available for external access. This part of the memory is also used to transfer information and parameters to the timer hardware extension and vice versa. In this case, the PCI adapter connects the bus of the timer hardware extension to the PC(I) bus. In all other cases, especially when the microcontroller is active, the internal bus is completely disconnected from the PC(I) bus or at least the address bus via the PCI adapter. In any case, the address logic (1) ensures that (only) then the corresponding chips are addressed when the respective address ranges are applied and distinguishes whether this is done from the outside (PC bus) or from the inside (microcontroller). About 90% of the RAM can be accessed only by the timer hardware extension CPU.

a) Protection Against Defects

So that the Original keys are protected from loss by a system/hardware error/restart in non-redundant systems, they can be saved (without Futurekey encryption) on the mentioned above Hardware extension (e.g. on a flash memory, in addition to the RAM of the timer hardware extension). This backup or transfer to the flash memory is also encrypted using the paused timer alarm time, which only the timer (and thus the timer hardware extension) and the timer program is known and wherein the reading of this special flash memory is basically locked and is possible only with additional on the system hardware to be performed security measures, such as pressing a key on the hardware device. Ideally, the hardware extension will also be protected against theft, including with binding to the respective system (including CPU-ID) could take place.

Such a flash memory could also be used as memory of the last e.g. 1000 Timekeys are used to create a backup.

Possibly, the flash memory should be mirrored several times and at least one of them has a galvanic isolation to the rest of the system.

However, if the system is not protected against all conceivable catastrophes, this measure makes no sense since in this case anyway a backup of the Original keys must be made as described in chapter T (backup). The backup on the timer hardware extension would then be an unnecessary risk.

In this case, it is better to run the memory just mentioned, not as flash memory, but as RAM so that the data on it is lost when the timer hardware extension is removed, which would be particularly important for the following chapter.

b) Parameters and Keys with Access Control

Of course, the Flash/RAM memory could also cache other secret data. In particular parameters for the application-specific functions or pointers. In this case, the transmission must be encrypted with the timer alarm value as a key (known only to the timer and the tinier program) and the timer hardware extension has to check if the read and write commands comes from the timer program.

For example, the memory of the timer hardware extension could also save Futurekeys.

Access to it (as with other data and parameters) will not be not allow by the timer hardware extension until the timer program is running, which is shortly after the timer is triggered. This would ensure that no other program gets access, since the timer program is running exclusively. In addition, the read access can be limited to one (per timer period).

The timer hardware extension makes this technically sure by holding all data only in the internal (working) memory (RAM) if these data has to excluded from any outside access, and only if access permission shall be granted, these dates are copied to the memory areas that can be accessed from the outside. The division of these areas is permanently installed in the address logic (1) of the timer hardware extension and can not be changed. (See FIG. 7) The internal memory can not be accessed from outside the timer hardware extension.

c) Especially Slow Memory as Matrix

In addition, the flash- or random access memory, or a part of it, or other memory that is externally addressable, could be by hardware-side built to perform read requests very slowly (e.g., <100 Mbit/sec). Thus it could be used to hide keys in it. Analogous to the concept presented in chapter L. (Description Claim 7: (HDD Matrix—hiding place Futurekeys)), a complete key could not be captured within its validity time if the attacker does not know exactly where the split key is stored in that slow memory. This can be a safety-enhancing variant/supplement to the matrix from E.2. (Memory-Random-Matrix), but also as an alternative for the storages used in Chapter L. (Description Claim 7: (HDD-Matrix—Hiding place Futurekeys)).

Since the timer program only needs to read the key (s) and knows where they are, their read access is e.g. in 1.3 microseconds done, whereas the scan/theft of a 1 GB matrix would take 80 seconds. As e.g. the Original keys only stay there for a maximum of about 3 seconds before they are encrypted again to Futurekeys, an attacker could only capture 1/25th of the matrix at this time. The great advantage of the memory on the timer hardware extension is also that it can ensure that accesses are allowed only while the timer program is (exclusively) active and could additionally control, from where and in which system memory areas the keys are been requested. Also, the timer hardware extension might detect someone trying to (randomly or systematically) access larger amounts of this memory and take appropriate action.

The security gain in contrast to the matrix in the main memory is again considerable (although not necessary from today's point of view). One could (and would have) increase the reading speed to 500 Mbit/sec. if the timer hardware extension also automatically, during the time in which the timer program is not active (timer is running), fills this memory area with new random numbers. At the end, this variant would result in no major performance losses. But of course classic main memory is much faster. You have to see how much the processor cache is able to compensate.

In order to better counter this potential performance disadvantage and still not lose security, the following procedure was developed . . . .

### P. DESCRIPTION CLAIM 10 (TRICKY MEMORY—HARDWARE EXTENSIONS)

Method according to one of the preceding claims, wherein

memory, as it et al can be accommodated on the timer hardware extension according to claim 2, is only accessible via a microcontroller/memory manager and this ensures that randomly carried out a part of the read accesses to this memory will be delayed processed/answered or rejected, unless it is read accesses to specific cells of this memory.

The microcontroller of the timer hardware extension acts like a memory manager, through which all memory accesses to a special memory run. This means that an external read access is directed to the microcontroller, which in turn switches the hardware extension to internal (PC(I) bus decoupled) and reads in the internal memory, which can only be selected—fixed by hardware—that way, and then provides the read value externally. In doing so, it ensures that the reading speed is limited or delayed that it is not possible to read the entire memory, or a certain area of it, in appropriate time or in a time that could be dangerous for the key or data stored therein. But he also ensures that reads (read access/read commands) to the memory cells in which the hidden key/Original key are stored, runs at maximum speed. These addresses are given to the microcontroller or the timer hardware extension via a specific method. In the case of the Original key, it can easily recognize the memory locations or distinguish them from memory commands with random values: These are the first (or last, if the matrix is filled by the timer program with random numbers) write commands after a timer alarm event (after the retrieval of the timer-alarm-time). These are the “specific cells” in the definition of claim 10. Since the timer program knows where the key(s) are located (pointer in the processor register), accesses to these keys would always be at maximum speed, whereas all others would be very slow. However, a certain number of reads after a certain event may also be meant as “specific cells”. For example, the first 512 bits (e.g., the first 2 256-bit keys) readed after a timer alarm event. Which works very effectively if the respective keys need to be readed only once per phase, as e.g. with futureskeys the case is.

1. Tricky memory for RAM matrix

However, this speed difference on reads would betray: this is (a part of) the real key. However, if the normal reading speed of 500 Mbit/sec. would be reduced to e.g. 1 Mbps. results no danger out of this, cause the attacker would not be able to find more than a part (for example ⅛) of the Original key and, statistically speaking, not until less then 62 attempts. Because the attacker could be able—in the 1 second in which the Original keys are present there—to read a maximum of 1 Mbit and thus 1/500th of a 64 MB matrix. However, multiple read commands from cells of the memory matrix in which the Original keys are not stored also show the microcontroller that an attack is underway. The timer hardware extension can then react accordingly.

Whereas in the case of the matrix according to claim 3 alone, the security results only from the untraceability in a huge amount of random numbers and thus possibilities, the security here results additionally in the impossibility to first read relevant sizes of the memory around the key and then within a large data volume to find the key. However, it is still necessary to fill this random memory matrix with random values, as it is a Original key stored there and it will not changes over the time, and an attacker might otherwise steal the right key piece by piece. However, this could also happen because the attacker recognizes real key parts at the high read speed. To prevent this, a) the microcontroller, randomly selected, will also answer about 50% of all reads at maximum speed, so that no conclusions can be drawn on genuine key parts, but reading of the entire memory matrix is still completely excluded, —and b) the size of the matrix has to be increased to 128 MB to compensate for the 50% fast reads.

The 50% exemplified herein corresponds to the “part” in “randomly a part of the read accesses” in the description of claim 10.

The procedural claim specified for the RAM matrix and thus storage of the Original key would be: Method according to one of the preceding claims, wherein

a special memory for storing the Original key in a RAM matrix is addressable only via the microcontroller of the timer hardware extension and this ensures that randomly on average 50% of all read accesses to this memory matrix are executed delayed so that the average reading speed is not more then 2 Mbps, unless it is a read access to the cells where the Original keys (parts) were stored.

The random numbers of the memory matrix must be constantly renewed, which could possibly do the timer hardware extension automatically; e.g. in the breaks in which the timer program does not work and thus reads on this memory are generally prevented.

However, in contrast to the matrix according to claim 3, chapter E.2, it is necessary here to ensure a reasonably even distribution of the key parts over the entire memory matrix, analogous to chapter L-claim 7. However, this could be realized by the microcontroller/memory manager autonomously so that there is no additional effort for the timer program.

The process could look like this:

The timer program writes an Original key to any memory cell of the matrix. The timer hardware extension, which automatically has filled the entire matrix with new random numbers 0.3 seconds after the last start of the timer, intercepts the Original key, divides it into 8 parts and randomly determines where in an imaginary in 8 parts divided memory matrix the respective parts has to be stored. The timer hardware extension remember/store the respective pointers to the key parts in their internal memory. The timer hardware extension proceeds analogously with further memory commands, whereby it always notices which memory address of the memory command is connected to the actual memory locations. If the timer program wants to read from the respective location again, the timer hardware extension recognizes that at the cached address and, using the associated real (pointer) addresses, searches together the parts of the key in the memory matrix and transfers the entire key to the timer program.

Now you might think that you do not need a matrix, because the write address used by the timer program (in principle the pointer, which may only be stored in the processor register), can simply be considered as a code and if that address again is requested, the timer hardware extension returns the Original key stored underneath but actually stored in the internal memory. Or it then executes the decryptions/cipherings as described in chapter O.3, O.4, in particular O.4.d).

If a different address is requested then the timer hardware extension returns a random number which it either (from time constraints) has taken from the memory matrix or has freshly generated. The latter, however, would tell an attacker that it was a fake key when the same cell is read a second time and then a new/other random value comes as a result. At the same time, however, system alarm and alarm sound should be triggered anyway if an attempt is made to read from an address that has not stored a key at all. For a system stop, the potential danger would not be high enough.

Well, if the address created of a code is a 64-bit number, then the security is (almost) the same as if an attacker knew the code function for the matrix pointer, and in contrast there it is no danger of dumping the memory matrix in the conventional main memory and the timer hardware extension notices if unauthorized memory accesses occur.

In order for the reads to be no more complex than classic read accesses to memory, it would be ideal if the timer hardware extension overlay the (virtual) memory of the matrix into the appropriate main memory area.

2. Tricky Memory for HDD Matrix

For reasons of performance—depending on the system—a realization of the matrix according to E.2. or claim 3 on the timer hardware extension may not make sense,—as a storage medium for claim 7, a correspondingly designed memory on the timer hardware extension, could be ideal. There are at least 3 interesting variants:
The timer hardware extension gets 3 GB of RAM, which is also not directly accessible, but only via the microcontroller of the timer hardware extension, which behaves like a memory manager. In this capacity it ensures that the read throughput is at e.g. 50 MByte/second. Similar to d) here, the microcontroller could answer the first 512 bit read request per timer phase at maximum speed and only then become slow. Because these keys (Futurekeys) need only be readed once per timer phase.
The timer hardware extension gets e.g. a 250 GB SSD. However, this is not directly accessible, but only via the microcontroller of the tinier hardware extension, which in turn provides a similar protocol available as HDD's. This means—the microcontroller acts as if it were a HDD or a HDD controller and at the same time ensures that the read speeds are below the respective limit. Again, techniques analogous to the mentioned above could be used to accelerate access to the real keys.
The futurekey which is to be hidden is held in the internal memory of the timer hardware extension and is thus not available from the outside, the microcontroller releasing it when the timer program retrieves it. Save and retrieve is done with a 256-bit code that is used as a write address. This is similar to the pointer used in the classical procedure of chapter L. This generates—on request—the timer hardware extension with the random number generator and transmits it to the timer program which encrypts him with the time code and/or Timekey.
“Release” means the microcontroller transfers the key to the externally available memory area, selects it and this passes the content to the data bus, or—depending on the capabilities of the microcontroller—this passes the key directly to the data bus so for the PCI Bus it acts like a normal result of the read access.

The transmission from and to the timer hardware extension should each be encrypted with the value of the last alarm time value or at least arithmetically processed with it. This ensures that both parties know each other authenticated and that the transmission can not be intercepted.

In addition, the timer hardware extension always checks whether the respective read or write accesses fits within the time frame, which can be estimated on the basis of the different phases. Thus, immediately after (within approximately 100 processor cycles) after the timer alarm event interrupt, the one-time read access for the timer alarm register must take place (and possibly for the time register) and immediately afterwards the read access for the futurekey. The write access for the Futurekey in turn takes place shortly after the timer has been reset. Any access outside of this rhythm or even multiple read or write accesses clearly show that a malicious program is trying to get involved.

Parallel to this, the timer hardware extension can always check whether the timer program is working by listening on the address bus.

Although the present method is only applied to keys here, it can ultimately be used for any data.

Although if here, or in a large part of the entire patent description, mainly flash memory is mentioned, the memory of the timer hardware extension should not be determined to it. Instead, any other type of memory may be used as long as it provides the required performance. Thus, only a small part of the non-volatility is beneficial. Much of the memory could and should be implemented as RAM or in the form of new developments in this area. The volatility is seen here rather as an advantage.

### Q. DESCRIPTION CLAIM 11: (INDIVIDUAL KEY)

Method according to one of the preceding claims, wherein

an additional one-way hash value is generated from passwords and/or login names and/or its parts and/or hash values of it, which is not stored permanently, but serves only the record belonging to the respective login/password, in addition to the Method according to Claims 1 and 4, to be individually encrypted or decrypted.

In order that any user can be sure, that even the administrator of the database server, who could illegally gain access to the Original keys because they were (scrambled) notified for backup reasons (see T “Backup”), can not access his or her data, is suggested to complete the method according to claim 4 (see chapter F—Description CLAUSE 4: (privacy system)) described as follows:

Upon login, in addition to the hash values which are generated and required for authentication, a further cryptological one-way hash value is created. For this, the password is hashed with a key, made of the associated login name or a hash of it (possibly deviating from a possibly standard credential hash instead of the plain text login name is transmitted to the server), and a different method is used than is used for the standard password hash. This second hash (Individual key) is also transferred to the server (according to the guidelines of chapter G) but not stored there permanently (in the database). It is used as a temporary cryptological key (similar to a session key) to additionally individually encrypt the data of the data set belonging to this user before it can be coded with the usual Original keys, e.g. according to chapter F (description of CLAIM 4: (privacy system)).

This requires the right combination of login name and password to decrypt the data. For example, even if someone has Masterkey and Timekey, he could gain access to the stored password hash, but since this is a one-way hash from which the original password can not be recovered, it is also not possible to get the Individual key. But this is needed to completely decrypt the data.

### R. FURTHER SAFETY ACTIONS

1. Application-Specific Functions

Functions, formulas and parameters, such as the function for editing the Masterkey according to claim 4, are intended to be application-specific.

This has already been mentioned in the respective chapters. It applies in particular to the following functions/formulas
Calculation of the time X from the system time
Calculation of the time code from time X and possibly other parameters
Calculation of the edited/changed Masterkey
Calculation of the hiding place for Masterkey-Futurekey
Calculation of hiding places for Masterkey and Timekey in the matrix
Calculation when new Timekey is to be generated

Functions fixed built into the program (kernel) could be find out “relatively easy” e.g. by decompilation.

This is not a significant problem, especially since most of the algorithms, functions, formulas and parameters used, as well as the encryption and hash methods to be used and, if applicable, their keys should be application-specific. In order to get to know them, the respective system must be infested or hijacked. Again, this would not be a serious problem, but is an additional security feature.

To further increase the challenges for an attacker, as many parameters as possible should be varied indefinitely within certain limits, but this is only permitted if they are completely safe from tampering, e.g. through malware. This can actually only be realized if parameters are stored on the timer hardware extension and it prevents those manipulations. An example of this can be found in O.1. (Hardware random number generation).

All application-specific formulas/functions must be protected against manipulation. Either they are fixed programmed during installation into the program code adopted by read-only memory (such as Eeprom) or at least irregularly checked frequently by checksums. Like the whole sensitive program code. If the software is delivered by e.g. ROM, the software manufacturer makes the respective individualization of the functions and parameters.

2. Software Integrity Audit Mechanism

As an additional security measure, especially if, due to the nature of the system, the direct execution of the program codes located in an e.g. Eeprom, is not possible, or even without timer hardware extension is working, several other programs including the main application check regularly (in very short intervals <0.05 milliseconds), sometimes mutually, whether it may exists manipulations of the interrupt pointer or the respective software (which is active in the working memory) and, if necessary, triggers a system alarm and, if also necessary, stops the system. This could be done either by complete or point-by-point comparison of the in-memory (encryption) programs with the program data on the Eeprom or by checksum hashing.

This technique assumes that a malicious program can not manipulate all affected programs at the same time. On the other hand, since this is not completely ruled out, this Method can only be considered as unbreakable if the timer hardware extension is used. Possibly. a TPM can remedy too. See 6.

3. Network

It could also be helpful if the system is disconnected from the network while the timer program is running or disconnected from the network itself. This could be done on the software side or for greater security and speed on the hardware side. A special function/extension of the network card or its connection to the system is conceivable here, in order to enable switching within nanoseconds.

4. Dump

In any case, in the executing system, the so-called memory and processor dump function must be deactivated and also not be able to be (re-)activated. Also in case of a processor error/crash. See the explanations in chapter E.2. “Memory Random Matrix”.

Alternatively, the procedures described in Chapter P must be used.

5. Time Attack

If the timer program is not exclusively working or there are other dangers that allow any measurement of time of the timer program's ciphering and deciphering activities, it must be explicitly ensured by randomly selected time wastage that due to the measurable working time no conclusions can be drawn on keys or type and extent of the processed data.

6. TPM

When operating the method without timer hardware extension, the integrity of the programs used and of the interrupt pointers can not be ensured by the timer hardware extension. At least one Trusted Platform Module (TPM) should then be used to ensure the integrity of the system (and the programs used). The interrupt pointer for the timer program must then also be repeatedly checked by the working programs. Again, it is by alarm and system stop to avert significant damage.

7. Shield

There are several ways to listen to the work of a computer. In various high and low frequency spectra, certain types of work and stress, in particular of the CPU, are audible. Often this occurs as a disturbance/interference of audio or radio signals. Although the inventor is not aware of such an attack, it is not inconceivable that any conclusions about the cipher work could be drawn from this—similar to the time attack. The system must therefore be shielded accordingly and also the power lines decoupled.

### S. ILLUSTRATION (SIMPLE CONFIGURATION)

If a user enters his/her credentials after registration in order to gain access to the respective website, this login request will first be queued. The Method shown in claim 5 for the special protection of the transmission of credentials shall been ignored here for simplifying reasons.

There is a web server with access to a database (database server) and the present layered protection method is either implemented in the database application so that the user inputs are filtered out prior to their connection/forwarding to the database and then, as far as it are credentials (or other sensitive data to be protected)—this protection method is in progress before datas being transferred to the database. Or, if there is only one web server, this Method could be interposed on this as well.

Incidentally, the protection method will also ensure that credentials are never deciphered because there is no need to do so. Furthermore, it will check for other deciphering requests (dot-like) whether a legitimate login exists for this request. If useful an internal (encrypted) list will be used to avert or reduce the risk of SQL attacks and login delusions.

Direct access to the database bypassing this privacy policy is not intended, but would only result in the seizure of the multiple encrypted data and would therefore be useless. The danger with SQL attacks is that the SQL server automatically decrypts any encryption before the data is submitted, which, however, can not happen here. The data protection method can not only check whether valid log-ins exists but also ensure that no more than an usual amount of data is granted within a certain periods of time and that the IPs of the respective clients are different. There are at least two design options:
The SQL server is addressed in the normal way and then sends the encryption or decryption requests to the data protection procedure via the buffer file. Disadvantage: It could theoretically be stored unencrypted data if the SQL server “forgets” to let them previously encrypt. Furthermore, the database server (application) would have to be adapted.
The database engine (interface of the server to the database) is adapted and intercepts SQL commands for reading and writing, forwards them to the data protection method and this then passes the data to the database after decryption or encryption.
   1. Passwords comes usually already double-hashed (from the front-end) or are encrypted by partially shortened one-way hashing immediately to unrestorable hash values.
   2. Login name, password and data are transferred to the protection procedure. This is done by adding the data as a new entry to a special (stack) file. It contains the cipher reason, the credentials and an assignment number of the request. Possibly associated additional data will also be buffered. Of course, other ways of cross-program data exchange would be possible, provided that they are secure.
   3. At time X, the repeatedly set timer will call (via interrupt) the corresponding timer program.
   4. This immediately blocks further interrupts and stores the system time and the timer values (delay time to compensate the time delay since timer expiration, or time code basis) and then stops eventually the network connection to the Web (server) and other threads if necessary.
   5. Now, the random matrix is prepared for the secure storage of the keys and the time code is calculated from the saved timer time/system time (possibly less the timer value) and from this the valid Timekey and the Masterkey are decrypted and, if necessary, the error correction is applied. To find the Masterkey Futurekey, the pointer to it is decrypted beforehand with the decoded Timekey. The Timekey Futurekey and the Masterkey Futurekey will be safely deleted (in the hiding place). Also the time code.
   6. Then the data are taken from the (stack) file, encrypted/deciphered and immediately deleted there safely.
      The login name is encrypted with the Masterkey and the Timekey, and the result is sent to the database as a search query. If the result is positive, the Masterkey is arithmetically edited with clear data of the data field number and the unique key of the data record, according to the application-specific formula, and the password hash is thus encrypted. Subsequently, the encryption takes place with the Timekey and the result (password-hash”) is compared with that of the database (or stored there if it is a registration). Possibly, further sensitive data (from the buffer) can be stored encrypted with a Masterkey to be new arithmetically edited and the Timekey.
      The login is coded in conjunction with the allocation number of the database record and the IP and this encrypted at least with the (other) Masterkey and/or Timekey stored in a login file.
   7. The cipher reason of the (stack) file entry decides the exact procedure. He starts eventually also other activities such as creating a backup, for example.
   8. The mentioned above (Stack-) file gets eventually an acknowledgment/feedback under the respective allocation number.
   9. Any temporary storages (variables) for the credentials extracted from the buffer file will be safely deleted.
   10. It is checked if a Timekey enciphering of the database is not yet completed and this then continued for e.g. 1 second. Once this is completed, it is calculated whether the Timekey is to be regenerated and if so it is initiated. The old Timekey is kept valid until the new enciphering is completed.
   11. The new hiding place for the Masterkey Futurekey is selected (randomly). The pointer on it is encrypted with a valid Timekey, whereby the original is not yet deleted.
   12. The new time X is defined and a 192-bit time code is calculate of it. This is made with extremely complex procedures of encryption and exponentiation with complex mass-digit numbers. From this new Futurekeys will be calculated and the timer is programmed accordingly.
   13. Masterkey and timekeys are safely deleted.
   14. If necessary, the network connection/Internet connection is reactivated.
   15. The Masterkey Futurekey is hidden and the original and the unencrypted pointer is safely deleted.
   16. Blocked threads and interrupts are reactivated and, if necessary, a message is sent to the web (server) application that the credentials have been processed or evaluated so that any further buffered requests may be forwarded.

Although here is spoken primarily about credentials but of course can be protected with this Method, all other data as well. It is recommended, however, that larger amounts of sensitive data are always encrypted with a separate Masterkey/Timekey and if they (the respective data field or the respective data column) need not be available for a database-wide search, the arithmetic editing of the Masterkey (before the further encryption by Timekey) shall be applied. Cause if a database is encrypted with a single key, it applies: the larger the amount of data, the easier it is to crack the key.

Of course, high-quality database systems have their own encryption. This is actually superfluous when using the present Method, but it does not hurt either. In particular, therefore, the application of the present Method need not worry about the encryption of the simpler and not so sensitive data. For example, with a bank server, it would be sufficient to have the credentials and e.g. account number and road name with the present process to be protected, whereby for account number and road name each a separate Original key could be used. All the rest of the data would be adequately secured with the database encryption because they would not cause any dramatic damage in the case of capture.

### T. BACKUP (AND SCRAMBLE CODES)

It can be assumed that from the database e.g. daily a backup has to be created. This is usually done on a separate backup drive. In this case, either the database is decoded using the Timekey, because this will be discarded after a short time, and then backed up (that is “only” encrypted with the arithmetically changed Masterkey), or the Timekey valid for this backup is printed out or the user is otherwise informed about it, so that the backup can be restored if necessary. Since the valid Timekey is unknown outside the timer program and can not be calculated until after the next timer expiration/trigger it could be reencrypted from the futurekey and the system time, this backup function must be executed by the timer subroutine.

So that the printed or communicated backup Timekey cannot be stolen outside of the system—in the real/material world (possibly together with the associated backup, e.g. from a safe)—it would make sense if the timer program saves the (e.g. 100 last)) Backup-Timekeys in a list, which is encrypted with the complete protection process and thus can not be captured. If a backup has to be restored, this will be communicated to the timer program (as well as the backup process) via a special request, and the backup will be loaded as instructed. The timer program will be informed of the date of the backup so it will be able to find the associated backup Timekey from the mentioned above list.

Possible hardware defects can be remedied with dual systems/redundancy. But not other (secular) catastrophes. For this reason, backups should never be kept in the same place as the source database or only in an extremely secure disk safe. For such cases, the Original keys—necessary for the decryption of the database backups—must also be stored in a safe place. The timer program offers the possibility to print them out in different ways. One of them is a scramble method for e.g. two code sheets are printed, which are to be kept in different places. Only if you put both superimposed against a strong light source you can read the key contained. However, this is recommended to be realized with 3 or 4 layers/sheets, which significantly increases safety. For deciphering, they must then be copied to film and superimposed or scanned and superimposed digitally. There are methods with monochrome and multicolor printouts, while the latter offering more possibilities for obfuscation. All application-specific parameters and functions must also be accommodated on these emergency code pages, as these also would be lost in a fire for example.

Of course, a full or partial online backup would be conceivable for securing these values, too. However, at least the same procedure should be used for transmission security, as shown for passwords under G.3. The safety of the transmitted values should again be ensured by the present Method. Since the risk is much higher due to the possible (purely theoretical) damage, the key sizes should be significantly larger (at least twice as large). The additional computing time can be accepted because nobody has to wait for it.

With regard to the Timekey, as already mentioned, either the Timekey encryption is removed before each backup or the Timekey is printed out using new scramble code. Of course this also contains the date of the backup.

If there is a system failure or error followed by a reset, the keys stored in the system are lost. In particular, the Timekey and the time code for deciphering the Futurekeys and also the pointers to their hiding places. The Original keys must then be entered directly after the restart. Since it is not practical to make a new scramble print (and brings them splitted to safety places) for each Timekey when renewal is made for example every hour, in this case the last backup with secure located Timekey would have to be restored.

This must not be necessarily, if the timer hardware extension itself does the encrypten/decryption tasks and stores the keys itself, which is only recommended if the timer hardware extension is protected against physical theft.

A printer interface can be accommodated on the timer hardware extension so that the scramble codes can be printed out directly.

A backup of any additional hardware keys of the encryption system of the timer hardware extension outside of this (because of any hardware defects) can be omitted if these encryption levels are omitted or removed during a backup, which in turn is only recommended if the backups are kept particularly highly secure.

### U. ALTERNATIVE FAILS

1. Generally Asymmetric Encryption

You might think that with the help of e.g. RSA encryption (asymmetric keys) and storage of the private/secret key in another secure location a similar security could be achieved because the possibly captured (public) key is not enough to decrypt the data (which usually not is necessary if it concerns only login data). But due to the rapid progress in the field of computing power, it is already clear that even keys with 2048-bit length can be calculated in the near future (factoring) as far as the public key is known. In this respect, a real or even long-term security would definitely not been given. (See estimates and forecasts of BSI, NIST, and Dirk Fox (Secorvo GmbH)) Above all, however, this handling would not be useful if even (sensitive) data must be deciphered again. Furthermore, the seizure of the private key could never be completely ruled out, as with any symmetrical key.

2. One-Way-Hashing

It would also be possible to exclude the real decryption of captured data, with strong one-way encryption, as it is partly done today by large companies (e.g., Yahoo). However, in this case it is possible to find equivalent values that come to the same result (hash value) and thus grant access even though the original real source value could not be recovered. In addition, 99% of all passwords can be found relatively quick with brute-force or dictionary attacks.

Furthermore, the problem would be that of course there is also data that cannot be encrypted with a one-way hashing because it is necessary to be able to restore it completely.

3. Trusted Platform Module

Although the general encryption by TPM (Trusted Platform Module) would also be possible and thus would also ensure that the key cannot be easily looted, providing that the endorsement key would be used because this (the private part) is known exclusively to the TPM However, due to the fact that this is always the same, an attack e.g. by cryptanalysis is quite conceivable and depending on the computing power possibly even in a reasonable time. In addition, there is the problem of a hardware defect and the risk of analyzing the key when using TPM encryption directly. Thus, an attacker could repeatedly let encrypt and decrypt various values by the TPM and analyze from this, which changes in the input value lead to which changes in the output value.

Above all, however, asymmetric encryption is already considered breakable if there is sufficient time. Overall, the functional scope of a TPM would not be sufficient for the majority of the security mechanisms present here.

Also, a TPM can not defend against abuse, as a malicious program could abuse the TPM to decrypt the data.

A TPM also does not offer the methods described here for securing against hardware errors.

The Method presented here is an overall concept which is unbeatable, above all, in the combination of timer hardware extension and timer program. The ever-changing keys and the arithmetic change of these are also crucial differences and advantages.

### V. RESULT

With this Method protected data/passwords can not be captured with current knowledge and foreseeable technology level. Even with a complete data theft and a pattern cryptanalysis and/or a brute force attack of a super computer on the captured data, a success in the next 150 years can be excluded and with a corresponding key strength also significantly longer. An online attack on the database directly can be excluded due to the multiple inhomogeneous encryption.

In the end, the main risk remains that the Original keys are captured, but this can be ruled out by the present Method since all the relevant keys are never actually present. Mainly only the Futurekeys are available, which—even if they were captured—could only be attacked with brute force in a stolen database. But due to the built-in timely brissance, the seizure of both keys is technically impossible. How to turn it and turn it, in the end, you could only play through at least 2̂256 options (at the minimum request of the key lengths). If you want to be on the sat side even after 150 years, you take 2 256-bit keys and the data is safe for 400 years. For example, with 2 384-bit keys, e.g. It's been 650 years before a top ten super computer is likely to crack all possibilities in a few years. From today's perspective, the necessary computing time exceeds the age and life of the universe for a long time yet. When the Futurekeys become valid can not be found out and during the short expiration time of the timer program, Masterkey and Timekey are hidden so that even with super computers in 1000 years it would be impossible to find out the actual Original keys. The coded pointer on it is, however, only stored in processor registers, which can not be accessed even with an hardware intervention.

Masterkey and Timekey are like spirits of the future—not here and if yes then not to see. (Therefore the name Ghosten/Ghosting)

Even the latent risk of seizing a complete memory and processor dump (including all processor registers) is excluded when using the Method steps from O.7.c) or the corresponding use of the timer hardware extension.

In addition, additional encryption levels with changing keys can be added via the timer hardware extension, but the methods described in Chapter 0.3 (Encryption and Decryption Functions) are completely sufficient, so that ultimately a memory and processor dump does not lead to a successful attack, because (parts of) the decryption I ciphering takes place in the hardware extension and the keys are there unreadable housed. They are generated on the hardware device and do not leave them. Since the keys change and in addition the timer hardware extension to a fixed key still holds a variable one, which similar to the Timekey being recreated at certain intervals, a crypto-analysis can be excluded.

Thus, the datas are absolutely safe even if the respective server is massively infected and malicious programs gain unrestricted access.

For some, the effort of this Method may seem as exaggerated.

Well, unfortunately, people (almost) only learn from mistakes or pain. In the past, most innovations in security were always invented when a successful attack revealed a vulnerability and through that further development has become needful.

That is not the case here. All possible attack scenarios are taken into account from the outset in this Method, although some (probably) have never been successful. There are so many layers of security that a successful attack can be ruled out for a long, long time. If the appropriate procedures and key variables are always adjusted and sophisticated, maybe even forever.

Since credentials are generally never been decrypted, an attacker could gain up to 4-fold encrypted data for their decryption the lifetime of the universe would not be enough.

### W. SEAL

If a server fulfills all the essential security components (of this Method), it receives a SEAL, which can be published on its portal and which (similar to the “Trusted Shop Guarantee Seal”) gives the user the certainty that his (login) data is safe here. An at least two-level quality classification makes sense to differentiate whether the maximum of the security mechanisms (including Timer Hardware Extension or TPM and handling of the most secure options) or only the minimum is used.

An extremely important advantage of the present Method is the fact that the security of the data protected here does not depend on whether an attacker knows the Method exactly or not.

### X. IDEAL DESIGN

There is no question that the ideal configuration of the Method requires the timer hardware extension. Since this hardware is able to exclude all major risks on the hardware side and thus is tamper-proof, the security (and in many situations also the performance) increases if it handles as many Method tasks as possible. Because it generates keys itself and keeps them safe, they can not be stolen. It is important, however, that only the timer program is allowed to use the decryption/ciphering services of the timer hardware extension. This is done via the control mechanisms of the timer hardware extension and the arithmetically processed transmission (see, i.a., D.6).

The timer hardware extension may also generate the changing public keys for transferring the data to the task buffer (C.6) and keep secret the private key necessary to decrypt that data. Thus, even the timer program would never “see” the data in plain text but only pass it on to the timer hardware extension, which then decrypts it asymmetrically and then encrypts it symmetrically with Masterkey and Timekey. In reverse data flow direction, the whole thing is reversed and then the recipient must provide a public key.

If the performance is sufficient, the transfer of all data can be expanded to the level described for passwords shown in G.3.

1. Method for saving data with multi-layer-protection, in particular log-on data and passwords, wherein
a) from keys used to encrypt data, referred to herein as the Original key, using a time code calculated from a system or alarm time value, referred to herein as time X, in relation to the current system time in the future, one each Key, which is referred to here as Futurekey, is calculated, and
b) subsequently the Original key(s) are deleted, and
c) a timer is programmed and started, so that it runs down or triggers at the time X and thus calls a timer program, which from the then present system time or timer alarm time the time code from a) again generated and thus from the Futurekeys recalculate the Original key used in a) to perform pending decryption and encryption tasks;
d) wherein the method described by a) to c) is repeated continuously and the respective time X, for each of which it is possible to calculate the Original key from the respective Futurekeys, is always programmed directly into a timer and stored information about this time X including the time code are deleted from all storage media except the timer;
e) wherein decryption and encryption tasks are cached until the next time X and then perform and process these tasks at time X by the above mentioned timer program. (FIG. 1)

2. Method of claim 1, wherein
the timer used from method step c) to d) of claim 1 is housed on an additional hardware, the timer hardware extension and—after the start of the timer—cannot at all be read until its expiration/triggering, and thereafter, can only be read once!

3. Method according to one of the preceding claims, wherein
any cryptographic keys, in particular in step c) of claim 1 recalculated Original keys, when stored in main memory, or other storage, as might be the case during their use for decryption and ciphering tasks of the timer program, either is split into a memory area of random numbers, the random matrix, are kept hidden, wherein the pointers to them being stored thereon exclusively in processor registers, or the keys themselves are stored exclusively in processor registers; wherein the memory area for the random matrix is to be filled with new random numbers each time before keys are hidden therein.

4. Method according to one of the preceding claims, wherein
for the protection of data they are sequentially encrypted with at least 2 different Original keys, each with different encryption methods, wherein
a) one of these Original keys, the Masterkey, each time before it is used to encrypt data, is edited so that this can be reconstructed for decryption again and yet as possible, each encryption is done with a slightly different Masterkey and
b) another Original key, the Timekey is generated again and again at certain intervals, in which case each encrypted data with the previous Timekey is decrypted and immediately re-encrypted with the newly generated Timekey, so that rotating ciphertext are generated. (FIG. 3)

5. Method according to one of the preceding claims, wherein
for the extended protection of passwords and/or login names, these are converted already during or immediately after the input, with a cryptologic one-way hashing into hash values, which partly or completely mutually serve as encryption key and are partly shortened/compressed and during transmission, in addition to any transport encryption such as HTTPS, by at least one other secret key and at least one sent by the recipient of the password code, the on both sides, so client and server, known password hash and/or login used essentially for generating the secret key and/or codes becomes. (FIG. 4)

6. Method according to one of the preceding claims, wherein
to disguise inputs the input-user of the computer used to receive instructions how he has to modify the upcoming input.

7. Method according to one of the preceding claims, wherein
data, but in particular cryptographic keys with a, to be renewed at certain intervals, key, here referred to as Timekey, encrypted and then split in several parts on a randomly filled, stored storage medium, wherein the maximum time interval for renewal of the Timekey and the associated new encryptions, the size of the storage medium and its reading speed are in such a relationship that the following applies: size in MByte>=read speed in MByte/sec.*Multiple*maximum time interval for renewal/re-encryption of the key in seconds.

8. Method according to one of the preceding claims, wherein
Programs and data which serve the data security of the data protected by the aforementioned claims, such as i.a. Software for enciphering and deciphering and the timer program mentioned in claim 1, on a non-volatile memory chip which can only be changed/written by means of manual hardware intervention, such as e.g. an EEPROM on the mentioned above Timer hardware extension, are housed and either this memory chip directly fades in/overlay a specific memory area of the main memory of the IT system, which performs the tasks of the preceding claims, or the mentioned above safety-relevant programs and data are loaded from it and regularly compared with it.

9. Method according to one of the preceding claims, wherein
the mentioned above Timer hardware extension according to claim 2 or another hardware device checks whether the for calling the timer program responsible interrupt pointer according to claim 1, was manipulated, which by the hardware shortly after the triggering of the timer independently check, whether the for the execution of the timer program responsible processor actually operates in the memory area in which the timer program is stored and otherwise triggers system alarms and/or stops the IT system containing the data to be protected;
wherein interrupt pointer means the start address of the timer program in the working memory of the executive IT system, which is entered as soon as the timer of claim 1 triggers.

10. Method according to one of the preceding claims, wherein
memory, as it et al can be accommodated on the timer hardware extension according to claim 2, is only accessible via a microcontroller/memory manager and this ensures that randomly carried out a part of the read accesses to this memory will be delayed processed/answered or rejected, unless it is read accesses to specific cells of this memory.

11. Method according to one of the preceding claims, wherein
an additional one-way hash value is generated from passwords and/or login names and/or its parts and/or hash values of it, which is not stored permanently, but serves only the record belonging to the respective login/password, in addition to the Method according to claims 1 and 4, to be individually encrypted or decrypted.
